(19) United States
(12) Patent Application Publication
(10) Pub. No.: US 2013/0030752 A1
(43) Pub. Date: Jan. 31, 2013

(54) OPERATION CHECK TEST METHOD, PROGRAM AND CLOCK DISTRIBUTION CIRCUIT

(71) Applicant: FUJITSU LIMITED, Kawasaki-shi (JP)

(72) Inventor: Akihiko KONMOTO, Kawasaki (JP)

(73) Assignee: FUJITSU LIMITED, Kawasaki-shi (JP)

(21) Appl. No.: 13/644,943

(22) Filed: Oct. 4, 2012

Related U.S. Application Data
(63) Continuation of application No. PCT/JP2010/056623, filed on Apr. 13, 2010.

(51) Int. Cl. G06F 19/00

(52) U.S. Cl. 702/117

(57) ABSTRACT

A method to perform an operation check test of a phase control circuit of a clock distribution circuit is disclosed that includes shifting one of the phases of the first differential signals and the second differential signals with reference to the other of the phases; obtaining an output data signal of the differential DFF to which the first differential signals and the second differential signals are input, one of the phases being shifted by the shifting; and comparing first values of the plural output data signals with first expected data values, the first values of the plural output data signals being obtained by performing the shifting and the obtaining repeatedly until phase differences of the first differential signals and the second differential signals reach one cycle of the first differential signals and the second differential signals.

### CROSS-REFERENCE TO RELATED APPLICATIONS

This application is a continuation application of International Application PCT/JP2010/056623 filed on Apr. 13, 2010 and designates the U.S., the entire contents of which are incorporated herein by reference.

### FIELD

The present disclosures relate to a technique for performing an operation check test of a phase control circuit of a clock distribution circuit.

### BACKGROUND

In a communication system which operates based on a synchronous clock, phases of plural input data may be different from each other because of transmission delay caused in cables connecting devices. Accordingly, the communication system includes a phase control circuit which controls the phase differences between the plural input data and corresponding output data. In the conventional communication system, an operation check test of the phase control circuit is performed in a state where the phase control circuit is mounted on the communication system.

There is a semiconductor apparatus which includes a test logic in a cache chip. In this semiconductor apparatus, the test logic reads a micro program from a tester disposed outside of the cache chip and performs an operation check test.

Conventionally, the operation check test is performed in the whole system or the whole apparatus on which the phase control circuit is mounted as described above.

In a case where the result of the operation check test shows an existence of a malfunction, it is difficult to confirm whether a cause of the malfunction has occurred in the phase control circuit or in a circuit or the like other than the phase control circuit.

In a case where an operating condition of the system or the apparatus on which the phase control circuit is mounted is limited and therefore an adjustable phase range of the phase control circuit is limited, there is an operating range of the system or the apparatus in which the operation check test can not be performed. In such a case, it is not possible to perform the operation check test in the whole operating range of the system or the apparatus on which the phase control circuit is mounted. Accordingly, there is a possibility of causing a reliability problem of the system or the apparatus.

### PRIOR ART REFERENCES

### Patent References

Patent Document 1: Japanese Laid-open Patent Publication No. 2003-32231
Patent Document 2: Japanese Laid-open Patent Publication No. 2005-283537

### SUMMARY

According to an aspect of an embodiment, a method carried out by a computer to perform an operation check test of a phase control circuit of a clock distribution circuit, the clock distribution circuit including a phase control circuit which controls at least one of phases of first differential signals and second differential signals, and a differential DFF which uses one of the first differential signals and the second differential signals as clock signals and obtains the other of the first differential signals and the second differential signals as data signals in synchronization with the clock signals is provided. The method carried out by the computer includes:

first shifting one of the phases of the first differential signals and the second differential signals with reference to the other of the phases of the first differential signals and the second differential signals;

first obtaining an output data signal of the differential DFF to which the first differential signals and the second differential signals are input, one of the phases of the first differential signals and the second differential signals being shifted by the first shifting; and

first comparing first values of the plural output data signals with first expected data values, the first values of the plural output data signals being obtained by performing the first shifting and the first obtaining repeatedly until phase differences of the first differential signals and the second differential signals reach one cycle of the first differential signals and the second differential signals.

The object and advantages of the invention will be realized and attained by means of the elements and combinations particularly pointed out in the appended claims.

It is to be understood that both the foregoing general description and the following detailed description are exemplary and explanatory and are not restrictive of the invention as claimed.

### BRIEF DESCRIPTION OF THE DRAWINGS

FIG. 1 is a diagram illustrating a server including a clock distribution circuit of a first embodiment;

FIG. 2 is a diagram illustrating a high-speed serial I/O receiving circuit including the clock distribution circuit of the first embodiment;

FIG. 3 is a diagram illustrating the high-speed serial I/O receiving circuit according to the first embodiment in a state where an LSI tester is connected to test ports;

FIG. 4 is a diagram illustrating an output data signal DFFq of differential DFF in a case where phase of a data signal DFFd is repeatedly shifted by 45 degrees in a step-by-step manner with respect to phase of a clock signal DFFck;

FIG. 5 is a diagram illustrating values of the output data signals DFFq with reference to output phases of control circuits A and B included in the clock distribution circuit according to the first embodiment;

FIG. 6A is a flowchart illustrating processes executed in a first step of the operation check test;

FIG. 6B is a flowchart illustrating processes executed in a second step of the operation check test;

FIG. 7 is a diagram illustrating the high-speed serial I/O receiving circuit according to an exemplary variation of the first embodiment.

FIG. 8 is a diagram illustrating a high-speed serial I/O receiving circuit including a clock distribution circuit of a second embodiment;

FIG. 9 is a flowchart illustrating processes executed in an operation check test of the second embodiment; and

FIG. 10 is a diagram illustrating a clock distribution circuit according to a third embodiment.

### DESCRIPTION OF EMBODIMENTS

A description is given, with reference to the accompanying drawings, of embodiments of a method for performing an operation check test, a computer-readable, non-transitory medium storing a program which, when executed by a computer, causes the computer to perform an operation check test, and a clock distribution circuit.

### First Embodiment

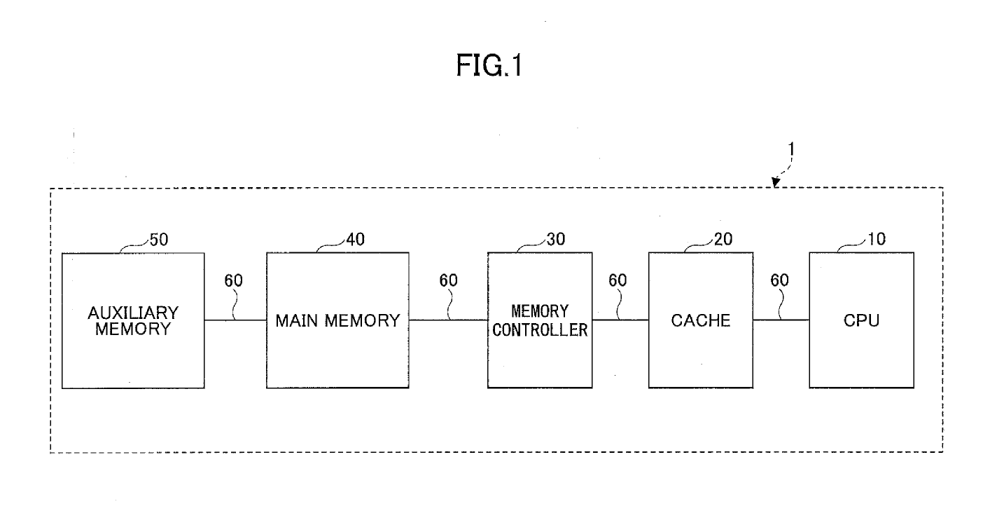

FIG. 1 is a diagram illustrating a server including a clock distribution circuit of the first embodiment.

The server 1 is a type of an information processing apparatus which includes a central processing unit (CPU) 10, a cache 20, a memory controller 30, a main memory 40 and an auxiliary memory 50. The CPU 10, the cache 20, the memory controller 30, the main memory 40 and the auxiliary memory 50 are connected by system buses 60, for example. Herein, the server 1 may include plural of the CPUs 10.

The cache 20 is a type of a memory which temporarily stores data used by the CPU 10 when the CPU 10 performs processing. A static random access memory (SRAM) may be used as the cache 20.

The memory controller 30 is a type of a controller which controls data read and written between the cache 20 and the main memory 40 based on a command output from the CPU 10.

The CPU 10, the cache 20 and the memory controller 30 may be realized by a large scale integration circuit (LSI), for example.

A read only memory (ROM) or a dynamic random access memory (DRAM) may be used as the main memory 40, for example. A hard disk may be used as the auxiliary memory 50, for example.

Herein, the server 1 may include a data input/output port or the like which is used for communicating with an external apparatus.

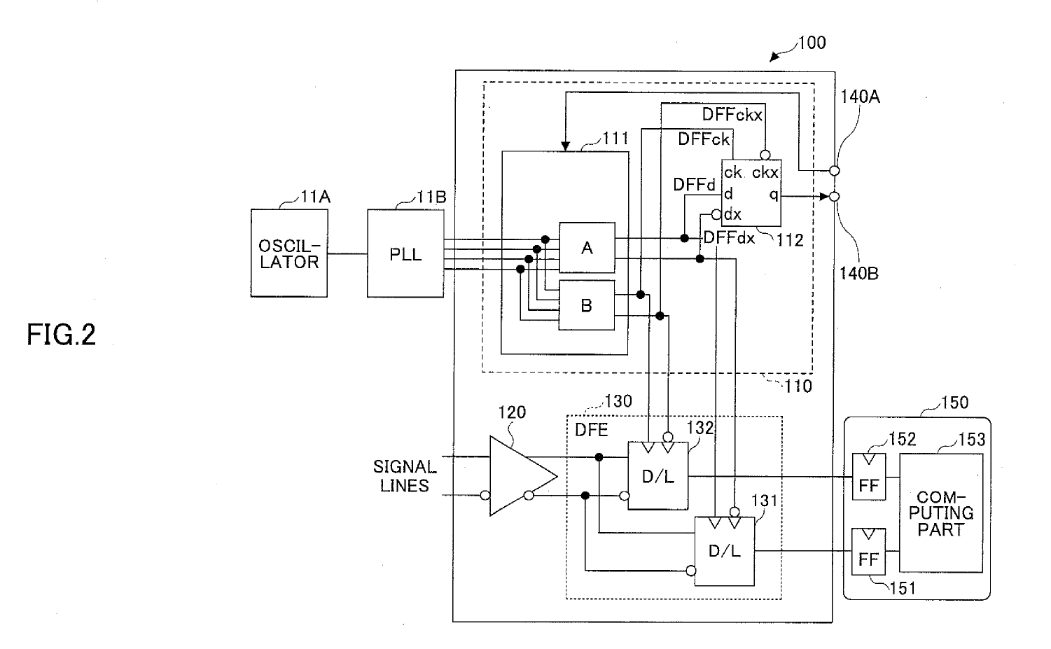

The clock distribution circuit of the first embodiment may be included in the CPU 10 or the memory controller 30 in the server 1, for example. Hereinafter, an embodiment in which the clock distribution circuit of the first embodiment is included in a high-speed serial I/O receiving circuit and the high-speed serial I/O receiving circuit is included in the CPU 10 (see FIG. 1) will be described. The high-speed serial I/O receiving circuit including the clock distribution circuit of the first embodiment will be described in detail with reference to FIG. 2.

FIG. 2 is a diagram illustrating the high-speed serial I/O receiving circuit including the clock distribution circuit of the first embodiment.

The high-speed serial I/O receiving circuit 100 includes a clock distribution circuit 110, an amplifier 120, a decision feedback equalizer (DFE) 130, and test ports 140A and 140B. The clock distribution circuit 110 includes a phase control circuit 111 and a differential DFF (D flip flop) 112. A data processing circuit 150 is connected to an output side of the DFE 130.

The phase control circuit 111 is a type of a two-phase and two-output phase control circuit. The phase control circuit 111 includes control circuits A and B. The CPU 10 (see FIG. 2) includes an oscillator 11A and a phase-locked loop (PLL) 11B. The oscillator 11A outputs a clock signal to the PLL 11B. The PLL 11B generates four-phase clock signals based on the clock signal input from the oscillator 11A. The four-phase clock signals are input to the phase control circuit 111 from the PLL 11B. The control circuits A and B of the phase control circuit 111 control phase delays of the four-phase clock signals and output two-phase clocks, respectively. The phase delays of the four-phase clock signals occur in transmission paths.

The control circuits A and B output the two-phase clock signals, respectively. The two-phase clock signals output from the control circuits A and B are differential clock signals. Phase difference of the differential clock signals is 180 degrees. The test port 140A is connected to the phase control circuit 111 via a signal line. The test port 140A is used when the operation check test of the clock distribution circuit 110 is performed. When the operation check test of the clock distribution circuit 110 is performed, a phase shift command is input to the test port 140A. The phase shift command is used for shifting the phases of the differential clock signals output from the control circuits A and B of the phase control circuit 111.

The differential DFF 112 includes data input terminals d and dx, clock input terminals ck and ckx, and a data output terminal q.

The data input terminals d and dx are connected to a pair of output terminals of the control circuit A. The differential clock signals output from the control circuit A are input to the data input terminals d and dx. The differential clock signals that are output from the control circuit A and input to the data input terminals d and dx may be referred to as data signals DFFd and DFFdx. In an exemplary embodiment as illustrated in FIG. 2, the non-inverted clock signal of the differential clock signals is input to the data input terminal d, and the inverted clock signal of the differential clock signals is input to the data input terminal dx.

The clock input terminals ck and ckx are connected to a pair of output terminals of the control circuit B. The differential clock signals output from the control circuit B are input to the clock input terminals ck and ckx. The differential clock signals that are output from the control circuit B and input to the clock input terminals ck and ckx may be referred to as clock signals DFFck and DFFckx. In an exemplary embodiment as illustrated in FIG. 2, the non-inverted clock signal of the differential clock signals is input to the clock input terminal ck, and the inverted clock signal of the differential clock signals is input to the clock input terminal ckx.

The data output terminal q outputs an output data signal which is strobed by the differential DFF 112.

The differential DFF 112 operates in synchronization with the differential clock signals that are input to the clock input terminals ck and ckx and strobes the differential clock signals that are input to the data input terminals d and dx. The differential DFF 112 outputs the output data signal from the data output terminal q. The differential DFF 112 uses the differential clock signals that are input to the clock input terminals ck and ckx as clock signals. The output data signal of the differential DFF 112 shows data level (‘0’ or ‘1’) of the differential clock signals that are input to the data input terminals d and dx, respectively.

According to the present embodiment, as illustrated in FIG. 2, the control circuit A is connected to the data input terminals d and dx of the differential DFF 112, and the control circuit B is connected to the clock input terminals ck and ckx of the differential DFF 112. Since the control circuits A and B output the differential clock signals, the control circuit B may be connected to the data input terminals d and dx of the differential DFF 112, and the control circuit A may be connected to the clock input terminals ck and ckx of the differential DFF 112. The differential DFF 112 is a type of a differential DFF which operates in synchronization with one pair of differential clocks among the two differential clocks output from the control circuits A and B, and strobes the other pair of differential clocks among the two differential clocks output from the control circuits A and B.

In the first embodiment, the differential DFF 112 uses the differential clocks output from the control circuit A as the data signals DFFd and DFFdx and uses the differential clocks output from the control circuit B as the clock signals DFFck and DFFckx. When the differential DFF 112 performs the operation check test, the differential DFF 112 shifts phases of the data signals DFFd and DFFdx with respect to phases of the clock signals DFFck and DFFckx and shifts the phases of the clock signals DFFck and DFFckx with respect to the data signals DFFd and DFFdx.

Since the differential DFF 112 is used for generating the output data signal which shows the result of the operation check test, the test port 140B is connected to the data output terminal q of the differential DFF 112 via a signal line. The detail of the operation check test will be described later.

A pair of input terminals of the amplifier 120 is connected to signal lines included in the CPU 10 (see FIG. 1). Data which is used for integer arithmetic or floating point arithmetic, for example, is input to the input terminals of the amplifier 120 from the CPU 10 via the signal lines.

The DFE 130 includes decision latches (D/Ls) 131 and 132. Output data of the amplifier 120 is input to the decision latches 131 and 132. The differential clock signals output from the control circuit A of the phase control circuit 111 are input to the decision latch 131, and the differential clock signals output from the control circuit B of the phase control circuit 111 are input to the decision latch 132. The decision latches 131 and 132 operate in synchronization with the differential clock signals output from the control circuits A and B and latch data input from the amplifier 120. The decision latches 131 and 132 output the latched data to the data processing circuit 150.

The data processing circuit 150 includes flip flops (FFs) 151 and 152 and a computing part 153. An input terminal of the FF 151 is connected to the decision latch 131, and an input terminal of the FF 152 is connected to the decision latch 132. Output terminals of the FFs 151 and 152 are connected to the computing part 153. The computing part 153 is a type of a circuit which can perform integer arithmetic or floating point arithmetic based on the data held by the FFs 151 and 152. The computing part 153 may be constituted of a logic circuit, for example.

The test ports 140A and 140B are types of ports to which the LSI tester is connected, in a case where the operation check test of the phase control circuit 111 of the clock distribution circuit 110 is performed. The phase shift command is input to the test port 140A from the LSI tester. The output data signal output from the data output terminal q of the differential DFF 112 is read by the LSI tester via the test port 140B.

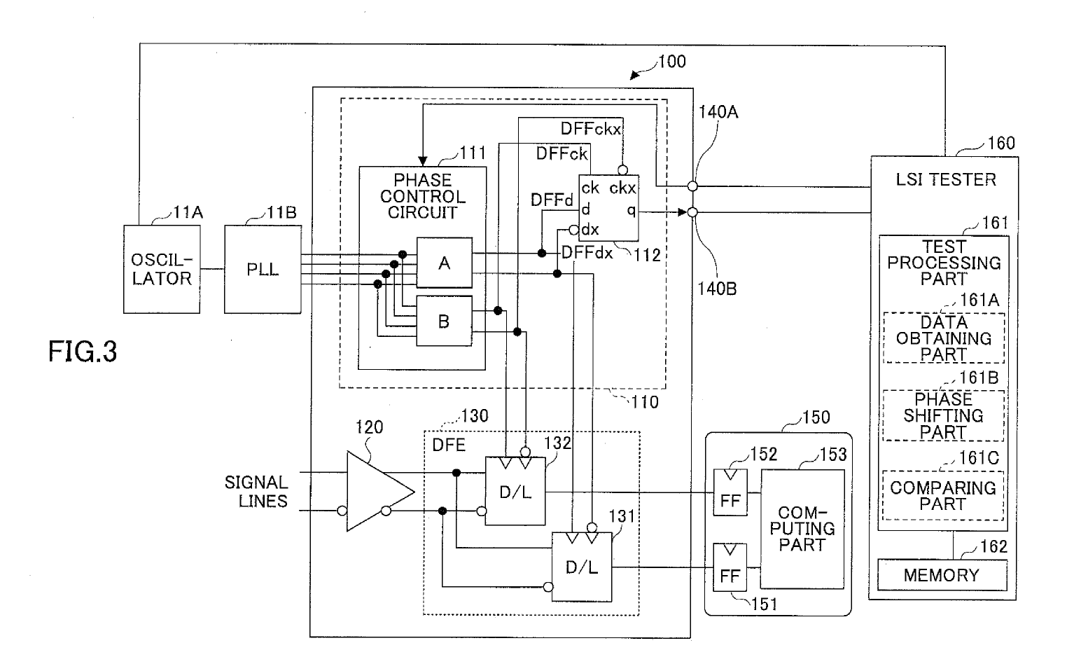

FIG. 3 is a diagram illustrating the high-speed serial I/O receiving circuit 100 according to the first embodiment in a state where an LSI tester 160 is connected to the test ports 140A and 140B.

The LSI tester 160 is a type of an operation check test apparatus which is provided outside of the server 1 (see FIG. 1). The LSI tester 160 is connected to the test ports 140A and 140B. The LSI tester 160 inputs the phase shift command to the high-speed serial I/O receiving circuit 100 via the test port 140A and reads the output data signal output from the data output terminal q of the differential DFF 112 via the test port 140B. The LSI tester 160 performs the operation check test of the phase control circuit 111 by comparing data of the output data signal with an expected value data.

The expected value data is a type data which is expected to be output from the data output terminal q of the differential DFF 112 in a case where the phase control circuit 111 operates normally.

The LSI tester 160 is a type of a processing unit which can execute a computer program of performing the operation check test of the phase control circuit 111. A computer may be used as the LSI tester 160, for example.

The LSI tester 160 includes a test processing part 161 and a memory 162. The test processing part 161 includes a data obtaining part 161A, a phase shifting part 161B and a comparing part 161C. The test processing part 161 executes the computer program of the operation check test and performs processing of the operation check test.

The data obtaining part 161A obtains output data output from the differential DFF 112 via the test port 140B and stores the output data into the memory 162. The output data signal output from the data output terminal q of the differential DFF 112 shows the output data.

The phase shifting part 161B inputs the phase shift command to the phase control circuit 111 via the test port 140A. Then the phases of the two pairs of the differential clock signals output from the control circuits A and B of the phase control circuit 111 are shifted. The phase shifting part 161B inputs the phase shift command repeatedly to the phase control circuit 111 until the phase differences between the differential clock signals output from the control circuit A and the differential clock signals output from the control circuit B reach one cycle of the two pairs of the differential clock signals. The single phase shift command causes one of the phases of the differential clock signals output from the control circuit A or B to shift for a designated phase unit.

The comparing part 161C compares the data of the output data signal output from the clock distribution circuit 110 with the expected value data. Since the phase shifting part 161B repeatedly outputs the phase shift command which causes the phases of the differential clock signals to shift for the designated phase unit, the comparing part 161C obtains the output data output from the clock distribution circuit 110 and compares the output data with the expected value data every time the phase shifting part 161B outputs the phase shift command.

Processes of the data obtaining part 161A, the phase shifting part 161B and the comparing part 161C are executed as processes of the LSI tester 160. Hereinafter, the processes will be described as being performed by the LSI tester 160.

The memory 162 stores the computer program of the operation check test and data obtained during the operation check test.

The LSI tester 160 transmits the phase shift command and an oscillation command to the phase control circuit 111 and the oscillator 11A, respectively, in a case where the LSI tester 160 performs the operation check test.

In the following, the operation check test of the phase control circuit 111 included in the clock distribution circuit 110 according to the first embodiment will be described. The operation check test of the first embodiment includes a first step and a second step. First of all, the first step of the operation check test will be described.

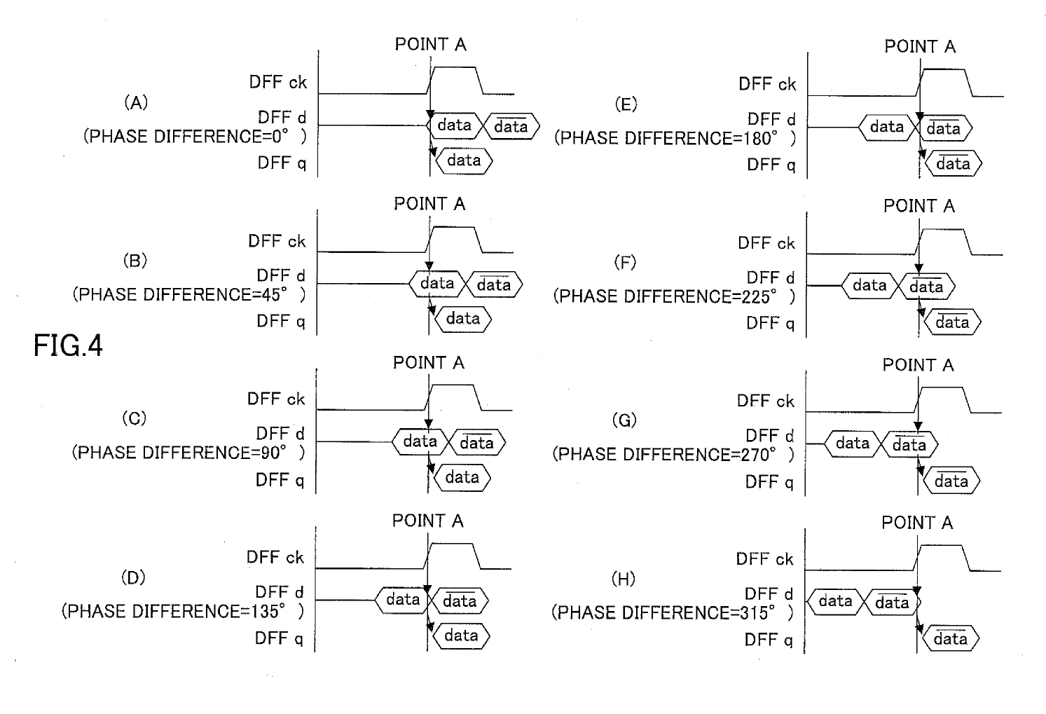

FIG. 4 is a diagram illustrating the output data signals DFFq of the differential DFF 112 in a case where the phase of the data signal DFFd is repeatedly shifted by 45 degrees in a step-by-step manner with respect to the phase of the clock signal DFFck. The data signal DFFd is input to the data input terminal d of the differential DFF 112 from the control circuit A. The clock signal DFFck is input to the clock input terminal ck of the differential DFF 112 from the control circuit B.

Herein, for example, the clock signal DFFck is the positive clock signal included in the differential clock signals that are input to the clock input terminals ck and ckx from the control circuit B, and the data signal DFFd is the positive clock signal included in the differential clock signals that are input to the data input terminals d and dx from the control circuit A. In FIG. 4, only the clock signal DFFck, the data signal DFFd and the output data signal DFFq are illustrated. The clock signal DFFck and the data signal DFFd are the positive signals of the clock signals DFFck and DFFckx and the data signals DFFd and DFFdx. The negative clock signal DFFckx and the negative data signal DFFdx appear in an inverted manner with reference to that of the positive clock signal DFFck and the positive data signal DFFd, respectively. Hereinafter, description of the negative signals may be omitted.

FIG. 4 illustrates the output data signals DFFq of the differential DFF 112 in a case where the phase of the clock signal DFFck is fixed and the phase of the data signal DFFd is repeatedly shifted by 45 degrees in a step-by-step manner with respect to the phase of the clock signal DFFck. The data signal DFFd is input to the data input terminal d of the differential DFF 112 from the control circuit A. The clock signal DFFck is input to the clock input terminal ck of the differential DFF 112 from the control circuit B.

The output data signal DFFq is output from the data output terminal q of the differential DFF 112.

In order to perform the first step of the operation check test, phase shifting of the data signal DFFd is performed based on the phase shift command input to the phase control circuit 111 from the LSI tester 160. Oscillation of the clock signal DFFck and the data signal DFFd is performed based on the oscillation command input to the phase control circuit 111 from the LSI tester 160.

In FIG. 4, for the purposes of illustration, “data” represents “0” and “data bar” represents ‘1’. The differential DFF 112 strobes the data signal DFFd in synchronization with the rising clock edge of the clock signal DFFck, i.e. the differential DFF 112 strobes the data signal DFFd when the rising clock edge of the clock signal DFFck occurs.

FIG. 4(A) illustrates a case in which the phase difference between the clock signal DFFck and the data signal DFFd is 0 degrees. In this case, the data signal DFFd is “data” when the rising clock edge of the clock signal DFFck occurs. Accordingly, the output data signal DFFq becomes “data”.

FIG. 4(B) illustrates a case in which the phase difference between the clock signal DFFck and the data signal DFFd is 45 degrees. In this case, the data signal DFFd is “data” when the rising clock edge of the clock signal DFFck occurs. Accordingly, the output data signal DFFq becomes “data”.

FIG. 4(C) illustrates a case in which the phase difference between the clock signal DFFck and the data signal DFFd is 90 degrees. In this case, the data signal DFFd is “data” when the rising clock edge of the clock signal DFFck occurs. Accordingly, the output data signal DFFq becomes “data”.

FIG. 4(D) illustrates a case in which the phase difference between the clock signal DFFck and the data signal DFFd is 135 degrees. In this case, the data signal DFFd is “data” when the rising clock edge of the clock signal DFFck occurs. Accordingly, the output data signal DFFq becomes “data”.

FIG. 4(E) illustrates a case in which the phase difference between the clock signal DFFck and the data signal DFFd is 180 degrees. In this case, the data signal DFFd is “data bar” when the rising clock edge of the clock signal DFFck occurs. Accordingly, the output data signal DFFq becomes “data bar”.

FIG. 4(F) illustrates a case in which the phase difference between the clock signal DFFck and the data signal DFFd is 225 degrees. In this case, the data signal DFFd is “data bar” when the rising clock edge of the clock signal DFFck occurs. Accordingly, the output data signal DFFq becomes “data bar”.

FIG. 4(G) illustrates a case in which the phase difference between the clock signal DFFck and the data signal DFFd is 270 degrees. In this case, the data signal DFFd is “data bar” when the rising clock edge of the clock signal DFFck occurs. Accordingly, the output data signal DFFq becomes “data bar”.

FIG. 4(H) illustrates a case in which the phase difference between the clock signal DFFck and the data signal DFFd is 315 degrees. In this case, the data signal DFFd is “data bar” when the rising clock edge of the clock signal DFFck occurs. Accordingly, the output data signal DFFq becomes “data bar”.

In a case where the phase of the data signal DFFd is repeatedly shifted by 45 degrees in a step-by-step manner with respect to the phase of the clock signal DFFck until the phase difference reaches one cycle of the data signal DFFd and the clock signal DFFck while the phase of the clock signal DFFck is fixed, the eight output data signals DFFq are obtained. Values of the eight output data signals DFFq become ‘00001111’.

The reason why the values of the eight output data signals DFFq include four ‘0’s and four ‘1’s is that the differential DFF 112 strobes ‘data’ (‘0’) four times in a half of one cycle and strobes ‘data bar’ (‘1’) four times in the rest of the cycle. The reason why the four ‘0’s and four ‘1’s appear consecutively in the eight output data signals DFFq is that the output data signal DFFq is “data” (‘0’) before the phase difference reaches 180 degrees, i.e. in the first half of the cycle, and that the output data signal DFFq is “data bar” (‘1’) after the phase difference reaches 180 degrees, i.e. in the second half of the cycle.

In a case where the phase control circuit 111 operates normally, and where the cycle is divided equally into eight parts, the differential DFF 112 outputs the output data signal DFFq eight times and the values of the eight output data signals DFFq become ‘00001111’ when the operation check test is performed eight times by shifting the phase of the data signal DFFd repeatedly by 45 degrees (one eighth of the cycle) in a step-by-step manner with respect to the phase of the clock signal DFFck.

Accordingly, in a case where number of ‘0’s and number of ‘1’s included in the values of the eight output data signals DFFq are different, such as the values of the eight output data signals DFFq ‘01001111’, for example, it turns out that one or more output data signals DFFq are incorrect and that the incorrect signal is generated by a malfunction of the phase control circuit 111.

Data point(s) where ‘0’s or ‘1’s occurs discontinuously and unexpectedly among the eight output data signals DFFq shows occurrence of the malfunction of the phase control circuit 111. In a case where the values of the eight output data signals DFFq become ‘01001111’ when the operation check test is performed eight times by shifting the phase of the data signal DFFd repeatedly by 45 degrees (one eighth of the cycle) in a step-by-step manner with respect to the phase of the clock signal DFFck as illustrated in FIG. 4, it turns out that the phase control circuit 111 does not operate normally when the phase difference is 45 degrees. The second data signal from the left among the eight output data signals DFFq ‘01001111’ corresponds to the case in which the phase difference between the clock signal DFFck and the data signal DFFd is 45 degrees. Operational examples as illustrated in FIG. 4 are obtained by shifting the phase of the data signal DFFd output from the control circuit A with respect to the clock signal DFFck output from the control circuit B. Accordingly, in a case where the values of the eight output data signals DFFq become ‘01001111’, it turns out that the control circuit A does not operate normally in an operating area where the phase of the data signal is shifted by 45 degrees or in a neighborhood area of the operating area.

In a case where the first step of the operation check test is performed while the LSI tester 160 is connected to the high-speed serial I/O receiving circuit 100, and where the phase of the data signal DFFd is shifted in a manner as illustrated in FIG. 4, the expected value data which is used in the LSI tester 160 may be set to be ‘00001111’. Accordingly, it becomes possible to determine whether the phase control circuit 111 operates normally or does not operate normally by comparing the output data signals DFFq obtained during the first step of the operation check test and the expected value data. The comparing process is performed in the LSI tester 160.

Although, the cycle (one cycle) is divided equally into eight parts in this embodiment, the number of parts into which the cycle is divided equally may not be limited to eight. The number of parts may be any number as long as it is more than or equal to two. In a case where the cycle is divided into n, where n represents an integer number more than or equal to two, the first step of the operation check test may be performed so that n output data signals DFFq can be obtained while shifting the phase difference between the clock signal DFFck and the data signal DFFd by one-nth of the cycle in a step-by-step manner.

In a case where n is an even number, the n output data signals DFFq show occurrence of the malfunction of the phase control circuit 111, if numbers of ‘0’ and ‘1’ included in the n output data signals DFFq are different. Otherwise, in a case where there is a data point(s) where ‘0’ or ‘1’ occurs discontinuously and unexpectedly among the n output data signals DFFq, the data point shows that the malfunction of the phase control circuit 111 occurs at the corresponding phase of the clock signal DFFck or the data signal DFFd.

In a case where n is an odd number, numbers of ‘0’ and ‘1’ included in the n output data signals DFFq are different. In this case, the occurrence of the malfunction of the phase control circuit 111 may be determined based on the occurrence of the data point(s) where ‘0’ or ‘1’ occurs discontinuously and unexpectedly among the n output data signals DFFq. In this case, error of the numbers of ‘0’ and ‘1’ is allowed as long as the number of the errors is one, i.e. not more than one.

In a case where the cycle is divided into n parts, where n represents an integer number more than or equal to two, the expected value data may be set to be a value in which respective ‘0’s and ‘1’s are arranged continuously, i.e. ‘0’ or ‘1’ does not occur discontinuously and unexpectedly, and in which the number of the errors of the numbers of ‘0’ and ‘1’ is one.

Herein, the first step of the operation check test may be performed not only in a case where the cycle is divided into n. The first step of the operation check test may be performed until the phase difference between the clock signal DFFck and the data signal DFFd reaches the cycle and plural output data signals DFFq are obtained while shifting the phase difference by a designated phase in a step-by-step manner. For example, the first step of the operation check test may be performed until the phase difference between the phase of the data signal DFFd and the phase of the clock signal DFFck reaches the cycle in order to obtain the plural output data signals DFFq while shifting any one of the phase of the data signal DFFd or the phase of the phase of the clock signal DFFck repeatedly by 50 degrees in a step-by-step manner in the phase control circuit 111.

In this case, the expected value data may be set to be a value in which respective ‘0’s and ‘1’s are arranged continuously, i.e. ‘0’ or ‘1’ does not occur discontinuously and unexpectedly, and in which the number of the errors of the numbers of ‘0’ and ‘1’ is one, i.e. not more than one.

In the embodiment as described above, the output data signals DFFq of the differential DFF 112 are illustrated in a case where the phase of the clock signal DFFck is fixed and the phase of the data signal DFFd is repeatedly shifted by 45 degrees in a step-by-step manner with respect to the phase of the clock signal DFFck. The data signal DFFd is input to the data input terminal d of the differential DFF 112 from the control circuit A. The clock signal DFFck is input to the clock input terminal ck of the differential DFF 112 from the control circuit B.

The values of the output data signals DFFq obtained in the embodiment as illustrated in FIG. 4 are ‘00001111’. In this embodiment, it turns out that the output data signal turns from ‘0’ to ‘1’ when the phase of the data signal DFFd is shifted from 135 degrees to 180 degrees. Accordingly, data change point at which the output data signal turns from ‘0’ to ‘1’ exists between when the phase of the data signal DFFd is 135 degrees and when the phase of the data signal DFFd is 180 degrees.

Herein, as a matter of practical convenience, the designated phase unit by which the phase of the data signal DFFd output from the control circuit A is shifted is set to be 45 degrees in a step-by-step manner as described above. In a practical sense, the designated phase unit may be set to be smaller value.

For example, in a case where the phase of the clock signal output from the control circuit A is repeatedly shifted by 5 degrees in a step-by-step manner with respect to the phase of the clock signal output from the control circuit B until the phase difference reaches one cycle (360 degrees) while the phase of the clock signal output from the control circuit B is fixed, seventy two output data signals are obtained. In this case, the cycle is divided equally into seventy two parts.

In this case, suppose that the seventy two output data signals include thirty four consecutive ‘0’s obtained between when the phase of the clock signal is 0 degrees and when the phase of the clock signal is 165 degrees, thirty six consecutive ‘1’s obtained between when the phase of the clock signal is 170 degrees and when the phase of the clock signal is 345 degrees, and two consecutive ‘0’s obtained between when the phase of the clock signal is 350 degrees and when the phase of the clock signal is 355 degrees.

In this case, it turns out that the output data signal turns from ‘0’ to ‘1’ when the phase of the clock signal output from the control circuit A is shifted from 165 degrees to 170 degrees. Accordingly, the data change point of the output data signal exists between when the phase of the clock signal output from the control circuit A is 165 degrees and when the phase of the clock signal output from the control circuit A is 170 degrees.

As described above, if the phase control circuit 111 shifts the phase of the clock signal by a smaller designated phase unit, it becomes possible to determine position of the data change point in a narrower phase range. The data change point exists in the phase range. Accordingly, the smaller the designated phase unit by which the phase control circuit 111 shifts the phase of the clock signal becomes, the narrower the phase range in which the data change point exists becomes.

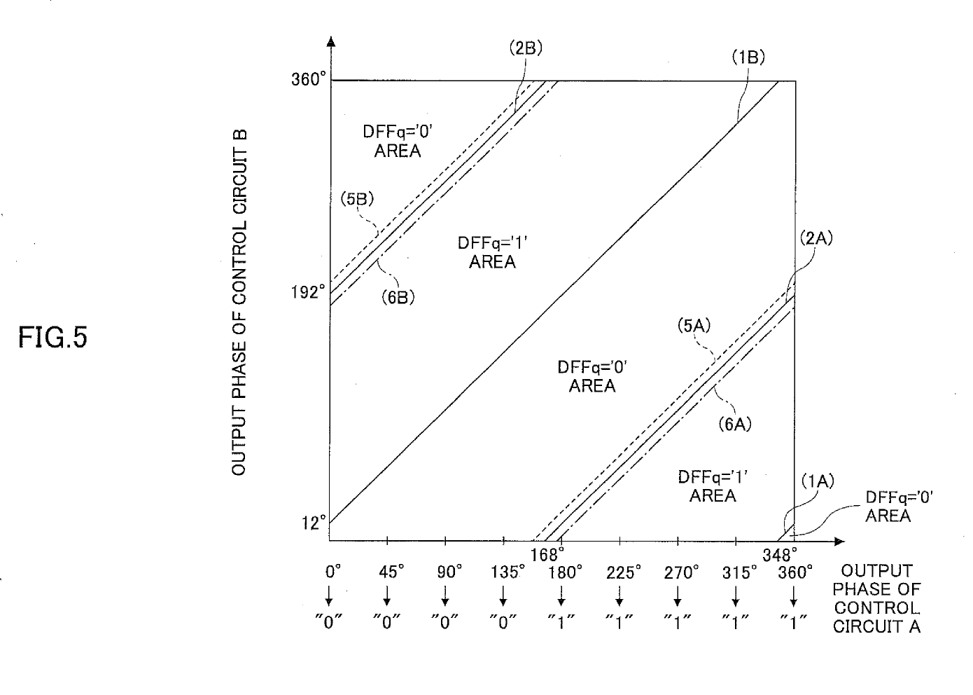

In the operation check test of the phase control circuit 111 included in the clock distribution circuit 110 of the first embodiment, a second step of the operation check test will be performed after determining the phase range at the first step. The phase range represents a range of the phase of the clock signal output from the control circuit A in which the data change point exists. A doctrine of the second step of the operation check test will be described with reference to FIG. 5.

Hereinafter, for example, the doctrine of the second step of the operation check test will be described in a case where the data change point is positioned at an operating point where the phase difference between the phase of the clock signal output from the control circuit A and the phase of the clock signal output from the control circuit B is 168 degrees. At the operating point, the phase of the clock signal output from the control circuit A is shifted by the control circuit A with reference to the phase of the clock signal output from the control circuit B. At the data change point, the output data signal turns from ‘0’ to ‘1’.

It is not possible to determine that the phase difference is 168 degrees at the operating point based on the seventy two output data signals obtained at the first step as described above. According to the second step, it becomes possible to perform the operation check test of the phase control circuit 111 included in the clock distribution circuit 110 more accurately than the first step, and thus it becomes possible to determine the position of the operating point more accurately than the first step.

FIG. 5 is a diagram illustrating the values of the output data signals DFFq with reference to the output phases of the control circuits A and B included in the clock distribution circuit 110 according to the first embodiment. The output phases represent the phase of the clock signal output from the control circuit A and the phase of the clock signal output from the control circuit B.

FIG. 5 illustrates the values of the output data signals DFFq that are obtained in an operational example in which the output data signal DFFq turns from ‘0’ to ‘1’ at the operating point where the phase difference between the phase of the clock signal output from the control circuit A and the phase of the clock signal output from the control circuit B is 168 degrees, for example. As illustrated in FIG. 5, the whole operating area as illustrated in FIG. 5 are divided into operating areas in which the output data signal DFFq becomes ‘0’ and operating areas in which the output data signal DFFq becomes ‘1’ with reference to the phase of the clock signal output from the control circuit A (output phase of the control circuit A) and the phase of the clock signal output from the control circuit B (output phase of the control circuit B).

In a case where the phase difference between the phase of the clock signal output from the control circuit A and the phase of the clock signal output from the control circuit B is 168 degrees and where the output data signal DFFq turns from ‘0’ to ‘1’, the phase difference (168 degrees) is a phase difference which appears at the data change point at which the output data signal turns from ‘0’ to ‘1’.

In FIG. 5, the horizontal axis represents the phase of the clock signal output from the control circuit A (the output phase of the control circuit A). The output phase of the control circuit A represents an amount by which the phase is shifted by the control circuit A. Hereinafter, the horizontal axis may be referred to as an axis A. In FIG. 5, the vertical axis represents the phase of the clock signal output from the control circuit B (the output phase of the control circuit B). The output phase of the control circuit B represents an amount by which the phase is shifted by the control circuit B. Hereinafter, the vertical axis may be referred to as an axis B. The whole operating area as illustrated in FIG. 5 is represented by the axis A and the axis B. The axis A ranges from 0 degrees to 360 degrees. The axis B ranges from 0 degrees to 360 degrees.

The whole operating area illustrated in FIG. 5 is divided into the operating areas in which the output data signal DFFq becomes ‘0’ (data) and the operating areas in which the output data signal DFFq becomes ‘1’ (data bar) in a case where the output phase of the control circuit A and the output phase of the control circuit B are shifted from 0 degrees to 360 degrees, respectively.

In the operational example as illustrated in FIG. 5, the data change point appears at the operating point where the phase difference between the phase of the clock signal output from the control circuit A and the phase of the clock signal output from the control circuit B is 168 degrees. In this operational example, boundaries between the operating areas in which the output data signal DFFq becomes ‘0’ (data) and the operating areas in which the output data signal DFFq becomes ‘1’ (data bar) are represented by formulae (1A), (1B), (2A) and (2B) as described below. Herein, combinations of numerals and letters in parenthesis, such as (1A), (1B), (2A) and (2B), represent straight lines that are expressed by the formulae (1A), (1B), (2A) and (2B), respectively.

B=A−348°(the output phase of the control circuit A is from 348 degrees to 360 degrees) (1A)

B=A+12°(the output phase of the control circuit A is from 0 degrees to 348 degrees) (1B)

B=A−168°(the output phase of the control circuit A is from 168 degrees to 360 degrees) (2A)

B=A+192°(the output phase of the control circuit A is from 0 degrees to 168 degrees) (2B)

The operating areas in which the output data signal DFFq becomes ‘0’ (data) are located in an area lower than the straight line (1A), an area between the straight lines (2A) and (1B), and an area above the straight line (2B).

The operating areas in which the output data signal DFFq becomes ‘1’ (data bar) are located in an area between the straight lines (1A) and (2A) and an area between the straight lines (1B) and (2B).

Since the phases of the clock signals output from the control circuits A and B can be shifted from 0 degrees to 360 degrees, the straight lines (1A) and (1B) expressed by the respective formulae (1A) and (1B) represent a single continuous boundary. Hereinafter, in a case where the formulae (1A) and (1B) are not distinguished, the formulae (1A) and (1B) may be referred to as a formula (1). Hereinafter, in a case where the straight lines (1A) and (1B) are not distinguished, the straight lines (1A) and (1B) may be referred to as a straight line (1).

Similarly, the straight lines (2A) and (2B) expressed by the respective formulae (2A) and (2B) represent a single continuous boundary. Hereinafter, in a case where the formulae (2A) and (2B) are not distinguished, the formulae (2A) and (2B) may be referred to as a formula (2). Hereinafter, in a case where the straight lines (2A) and (2B) are not distinguished, the straight lines (2A) and (2B) may be referred to as a straight line (2).

The output data signal DFFq becomes ‘1’ on the straight lines (1A) and (1B) and becomes ‘0’ on the straight lines (2A) and (2B).

In a case where the phase of the clock signal output from the control circuit B is fixed and the phase of the clock signal output from the control circuit A is repeatedly shifted by 45 degrees in a step-by-step manner with respect to the phase of the clock signal output from the control circuit B, the eight output data signals DFFq are obtained on the axis A. Coordinate values of the eight output data signals DFFq are obtained on (0°,0°), (45°,0°), (90°,0°), (135°,0°), (180°,0°), (225°,0°), (270°,0°) and (315°,0°) in the AB coordinate system as illustrated in FIG. 5.

The operational example as illustrated in FIG. 5 is obtained in a case where the data change point at which the output data signal DFFq turns from ‘0’ to ‘1’ appears at the operating point in which the phase difference between the clock signal output from the control circuit A and the clock signal output from the control circuit B is 168 degrees.

The formulae (1A), (1B), (2A) and (2B) are expressed by general formulae (3A), (3B), (4A) and (4B) where the phase difference at which the data change point appears is expressed as α°. Herein, the phase difference α degree(s) is expressed as the positive value in a case where the phase of the clock signal output from the control circuit A leads with reference to the phase of the clock signal output from the control circuit B.

B=A−(180+α)°(the output phase of the control circuit A is from(α+180)degrees to 360 degrees) (3A)

B=A+(180−α)°(the output phase of the control circuit A is from 0 degrees to(α+180)degrees) (3B)

B=A−α°(the output phase of the control circuit A is from α degree(s)to 360 degrees) (4A)

B=A+(360−α)°(the output phase of the control circuit A is from 0 degrees to α degree(s)) (4B)

In a case where the phase difference is expressed as a degree (s) at which the data change point appears, the boundaries between the operating areas in which the output data signal DFFq becomes ‘0’ (data) and the operating areas in which the output data signal DFFq becomes ‘1’ (data bar) are represented by formulae (3A), (3B), (4A) and (4B) as described above.

It is not possible to determine the phase difference α degree(s) at which the data change point appears based on the output data signals DFFq. However it becomes possible to narrow down a range in which the phase difference α appears to a certain narrow range by decreasing the phase difference between the clock signal output from the control circuit A and the clock signal output from the control circuit B when performing the operation check test in order to obtain plural of the output data signals DFFq. Accordingly, it becomes possible to catch the phase difference α at which the data change point of the output data signal DFFq appears between two values. These two values are neighborhood values that exist ahead of and behind the phase difference α at which the data change point of the output data signal DFFq appears.

For example, in a case where the phase difference α at which the data change point of the output data signal DFFq appears is 168 degrees and where the phase of the clock signal output from the control circuit A is repeatedly shifted by 5 degrees in a step-by-step manner with respect to the phase of the clock signal output from the control circuit B until the phase difference reaches one cycle (360 degrees) while the phase of the clock signal output from the control circuit B is fixed, seventy two output data signals DFFq are obtained. In this case, it is possible to catch the phase difference α (168 degrees) between when the phase of the clock signal output from the control circuit A is 165 degrees and when the phase of the clock signal output from the control circuit A is 170 degrees. As a result, in this operational example, the phase difference α at which the data change point of the output data signal DFFq appears is 168 degrees, and the two neighborhood values are 165 degrees and 170 degrees.

In the first embodiment, the second step of the operation check test is performed by shifting the phases of the clock signals output from the control circuits A and B from 0 degrees to 360 degrees at the same time while fixing the phase difference of the clock signals to the neighborhood values. Since there are two neighborhood values, it is possible to perform the operation check test with respect to both of the two neighborhood values.

The second step of the operation check test will be described in detail with reference to the operational example as illustrated in FIG. 5. For example, the second step of the operation check test is performed by shifting the phases of the clock signals output from the control circuits A and B from 0 degrees to 360 degrees at the same time while fixing the phase difference of the clock signals to one of the neighborhood values, for example, 165 degrees, and is performed by shifting the phases of the clock signals output from the control circuits A and B from 0 degrees to 360 degrees at the same time while fixing the phase difference of the clock signals to another neighborhood value, for example, 170 degrees.

More specifically, the first half of the second step of the operation check test is performed by shifting the phases of the clock signals output from the control circuits A and B from 0 degrees to 360 degrees at the same time so that the phases of the clock signals satisfy relationships defined by formulae (5A) and (5B), while fixing the phase difference of the clock signals to one of the neighborhood values. The second half of the second step of the operation check test is performed by shifting the phases of the clock signals output from the control circuits A and B from 0 degrees to 360 degrees at the same time so that the phases of the clock signals satisfy relationships defined by formulae (6A) and (6B), while fixing the phase difference of the clock signals to another neighborhood value. Herein, combinations of numerals and letters in parenthesis, such as (5A), (5B), (6A) and (6B), represent straight lines that are expressed by the corresponding formulae (5A), (5B), (6A) and (6B), respectively.

B=A−165°(the output phase of the control circuit A is from 165 degrees to 360 degrees) (5A)

B=A−165°(the output phase of the control circuit A is from 0 degrees to 165 degrees) (5B)

B=A−170°(the output phase of the control circuit A is from 170 degrees to 360 degrees) (6A)

B=A−170°(the output phase of the control circuit A is from 0 degrees to 170 degrees) (6B)

Hereinafter, in a case where the formulae (5A) and (5B) are not distinguished, the formulae (5A) and (5B) may be referred to as a formula (5). Hereinafter, in a case where the straight lines (5A) and (5B) are not distinguished, the straight lines (5A) and (5B) may be referred to as a straight line (5). Hereinafter, in a case where the formulae (6A) and (6B) are not distinguished, the formulae (6A) and (6B) may be referred to as a formula (6). Hereinafter, in a case where the straight lines (6A) and (6B) are not distinguished, the straight lines (6A) and (6B) may be referred to as a straight line (6).

The straight line (5A) expressed by the formula (5A) is located three degrees above the straight line (2A) expressed by the formula (2A) in the direction of the B axis, and is located in the operating area in which the output data signal DFFq becomes ‘0’. The straight line (5B) expressed by the formula (5B) is located three degrees above the straight line (2B) expressed by the formula (2B) in the direction of the B axis, and is located in the operating area in which the output data signal DFFq becomes ‘0’.

Accordingly, it becomes possible to determine the value of the output data signal DFFq on the straight line (5) located nearby the straight line (2) by shifting the phases of the clock signals output from the control circuits A and B from 0 degrees to 360 degrees at the same time while fixing the phase difference of the clock signals so that the phase difference satisfies the formula (5). As a result, it is possible to perform the operation check test of the phase control circuit 111 with a high degree of accuracy.

The straight line (5) is located in the area in which the output data signal DFFq becomes ‘0’. If the phase control circuit 111 operates normally, all of the values of the output data signals DFFq obtained during the second step of the operation check test become ‘0’.

If any of the values of the output data signals DFFq obtained during the second step of the operation check test become ‘1’, the result of the second step shows occurrence of the malfunction of the phase control circuit 111.

The straight line (6A) expressed by the formula (6A) is located two degrees below the straight line (2A) expressed by the formula (2A) in the direction of the B axis, and is located in the operating area in which the output data signal DFFq becomes ‘1’. The straight line (6B) expressed by the formula (6B) is located two degrees below the straight line (2B) expressed by the formula (2B) in the direction of the B axis, and is located in the operating area in which the output data signal DFFq becomes ‘1’.

Accordingly, it becomes possible to determine the value of the output data signal DFFq on the straight line (6) located nearby the straight line (2) by shifting the phases of the clock signals output from the control circuits A and B from 0 degrees to 360 degrees at the same time while fixing the phase difference of the clock signals so that the phase difference satisfies the formula (6). As a result, it is possible to perform the operation check test of the phase control circuit 111 with a high degree of accuracy.

The straight line (6) is located in the area in which the output data signal DFFq becomes ‘1’. If the phase control circuit 111 operates normally, all of the values of the output data signals DFFq obtained during the second step of the operation check test become ‘1’.

If any of the values of the output data signals DFFq obtained during the second step of the operation check test become ‘0’, the result of the second step shows occurrence of the malfunction of the phase control circuit 111.

In the embodiment as described above, the second step of the operation check test is performed by fixing phase difference of the clock signals output from the control circuits A and B to the two neighborhood values, 165 degrees and 170 degrees. In other words, in the embodiment as described above, the second step of the operation check test is performed with respect to the two neighborhood values. The second step of the operation check test may be performed with respect to any one of the two neighborhood values. In this case, either of the two neighborhood values may be used for the second step of the operation check test.

In the embodiment as described above with reference to FIG. 5, the second step of the operation check test is performed by fixing the phase difference between the clock signals output from the control circuits A and B to the two neighborhood values, i.e. 165 degrees and 170 degrees, in a case where the data change point at which the output data signal DFFq turns from ‘0’ to ‘1’ appears at the operating point in which the phase difference between the clock signal output from the control circuit A and the clock signal output from the control circuit B is 168 degrees. However, the second step of the operation check test can be performed with respect to any degree(s) of the phase difference α (from 0 degrees to 360 degrees) by fixing the phase difference between the clock signals output from the control circuits A and B to the neighborhood value(s) of the phase difference α.

Although the doctrine of the second step of the operation check test by utilizing the straight lines (5) and (6) that are located nearby the straight line (2) is described above, there is a boundary along the straight line (1). The straight line (1) is located at a position which is different from that of the straight line (2) by 180 degrees in the respective directions of the axes A and B. Accordingly, the second step of the operation check test can be performed with respect to the straight line (2) instead of the straight line (1), or can be performed with respect to both of the straight lines (1) and (2).

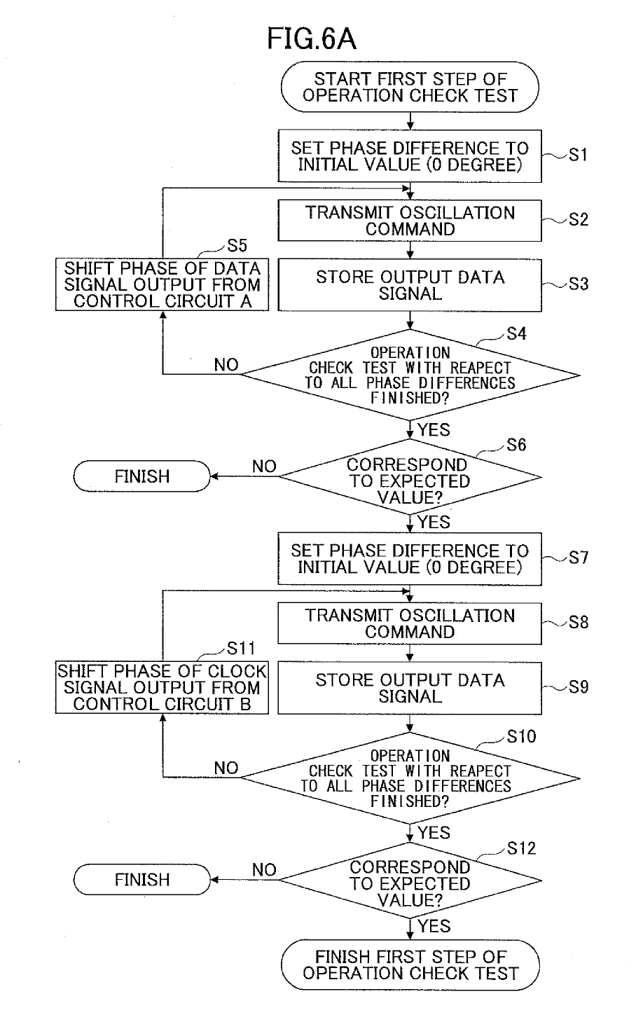

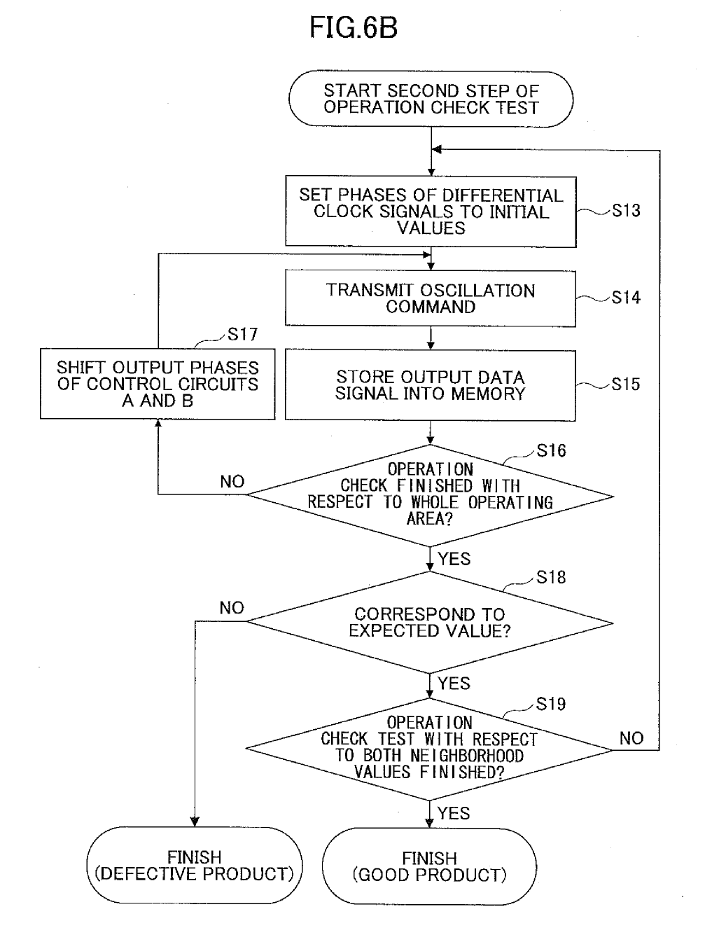

FIG. 6A is a flowchart illustrating processes executed in the first step of the operation check test. The processes as illustrated in FIG. 6A are executed by the LSI tester 160 which is connected to the high-speed serial I/O receiving circuit 100 according to the first embodiment.

Herein, a case in which the phase of the data signal DFFd input to the differential DFF 112 is repeatedly shifted by 5 degrees in a step-by-step manner with respect to the phase of the clock signal DFFck input to the differential DFF 112 while the phase of the clock signal DFFck is fixed, and the seventy two output data signals DFFq are obtained from the differential DFF 112 will be described. In this case, the cycle (one cycle) is divided equally into seventy two parts.

At first, the LSI tester 160 performs the first step of the operation check test based on the output data signals DFFq output from the data output terminal q of the differential DFF 112 by shifting the phase of the data signal DFFd output from the control circuit A by 5 degrees in a step-by-step manner with respect to the phase of the clock signal DFFck output from the control circuit B while the phase of the clock signal DFFck is fixed. In other words, the LSI tester 160 performs the first step of the operation check test by shifting the phases of the differential clock signals that are input to the data input terminals d and dx of the differential DFF 112 from the control circuit A as the data signals DFFd and DFFdx. The LSI tester 160 can check the operation of the control circuit A by executing the processes as described above.

Then, the LSI tester 160 continues and performs the first step of the operation check test based on the output data signals DFFq output from the data output terminal q of the differential DFF 112 by shifting the phase of the clock signal DFFck output from the control circuit B by 5 degrees in a step-by-step manner with respect to the phase of the data signal DFFd output from the control circuit A while the phase of the data signal DFFd is fixed. In other words, the LSI tester 160 continues and performs the first step of the operation check test by shifting the phases of the differential clock signals that are input to the clock input terminals ck and ckx of the differential DFF 112 from the control circuit B as the clock signals. The LSI tester 160 can check the operation of the control circuit B by executing the processes as described above.

More specifically, sequence of the first step of the operation check test is as follows. Hereinafter, the sequence will be described with respect to the positive clock signal of the differential clock signals output from the control circuit A and the positive clock signal of the differential clock signals output from the control circuit B, since the respective negative clock signals appear in an inverted manner with reference to the respective positive clock signals. Accordingly, hereinafter, description of the negative clock signals will be omitted in a case where there is no need to distinguish and describe the negative clock signals.

The LSI tester 160 sets the phase difference between the clock signal output from the control circuit A and the clock signal output from the control circuit B to an initial value (0 degree) (step S1). Since the phase difference between the clock signals output from the control circuits A and B is 0 degrees, the phase shift command which is transmitted from the LSI tester 160 to the phase control circuit 111 represents 0 degrees.

The LSI tester 160 transmits the oscillation command to the oscillator 11A in order to cause the oscillator 11A to output the clock signal (step S2). Then the oscillator 11A outputs the clock signal to the PLL 11B, and the PLL 11B generates the four-phase clock signals and inputs them to the phase control circuit 111. The control circuits A and B of the phase control circuit 111 output the differential clock signals, respectively. At this moment, the phase difference between the two pairs of the differential clocks is 0 degrees. The differential clock signals output from the control circuit A are input to the data input terminals d and dx of the differential DFF 112, and the differential clock signals output from the control circuit B are input to the clock input terminals ck and ckx. The differential DFF 112 outputs the output data signal DFFq from the data output terminal q. In a case where the phase difference of the clock signals output from the control circuits A and B is 0 degrees, the output data signal DFFq becomes ‘0’ (data) as illustrated in FIG. 4A.

The LSI tester 160 stores the value of the output data signal DFFq output from the differential DFF 112 into the memory 162 (step S3).

The LSI tester 160 determines whether the operation check test has been finished with respect to all of the predetermined phase differences (step S4). More specifically, at step S4, the LSI tester 160 determines whether the operation check test has been finished by repeatedly shifting the phase of the clock signal output from the control circuit A by 5 degrees in a step-by-step manner until the phase difference reaches 355 degrees so that the phase difference covers the cycle (360 degrees). In this case, the cycle is equally divided into seventy two parts.

If the LSI tester 160 determines that the operation check test has not been finished with respect to all of the phase differences (S4: NO), the LSI tester 160 returns to step S5. The LSI tester 160 causes the control circuit A to shift the phases of the data signals DFFd and DFFdx output from the control circuit A by 5 degrees (step S5). As a result, the phases of the differential data signals DFFd and DFFdx are shifted by 5 degrees with reference to the phases of the differential clock signals DFFck and DFFckx.

The LSI tester 160 goes to step S2 after finishing the process of step S5. Accordingly, the processes of steps S2 to S4 are repeatedly executed by the LSI tester 160 until the operation check test has been finished with respect to all of the phase differences. After executing the processes of steps S2 to S5 repeatedly until the phase of the data signal DFFd reaches 355 degrees, the seventy two output data signals DFFq are stored in the memory 162 of the LSI tester 160.

If the LSI tester 160 determines that the operation check test has been finished with respect to all of the phase differences at step S4 (S4: YES), the LSI tester 160 goes to step S6. The LSI tester 160 compares the data of the seventy two output data signals DFFq with the expected value data and determines whether the data of the seventy two output data signals DFFq corresponds to the expected value data (step S6).

If the seventy two output data signals DFFq include thirty six ‘0’s and thirty two ‘1’s and do not include the data point(s) where ‘0’ or ‘1’ occurs discontinuously and unexpectedly, the LSI tester 160 determines that the seventy two output data signals DFFq correspond to the expected value data. In this case, the control circuit A passes the operation check test. In other words, the LSI tester 160 determines that the clock distribution circuit 110 including the phase control circuit 111 is a good product (non-defective product) at least with respect to the control circuit A.

If number of ‘0’s and number of ‘1’s included in the seventy two output data signals DFFq are different or the seventy two output data signals DFFq include the data point(s) where ‘0’ or ‘1’ occurs discontinuously and unexpectedly, the LSI tester 160 determines that the seventy two output data signals DFFq do not correspond to the expected value data. In this case, the clock distribution circuit 110 including the phase control circuit 111 does not pass the operation check test. In other words, the LSI tester 160 determines that the clock distribution circuit 110 including the phase control circuit 111 is a defective product.

If the LSI tester 160 determines that the data of the output data signals DFFq corresponds to the expected value data at step S6, the LSI tester 160 goes to steps S7 to S12 in order to perform the operation check test of the control circuit B. Processes of steps S7 to S12 are similar to those of steps S1 to S6 except for shifting the phases of the clock signals DFFck and DFFckx by 5 degrees in a step-by-step manner instead of the data signals DFFd and DFFdx.

The LSI tester 160 sets the phase difference between the clock signal output from the control circuit A and the clock signal output from the control circuit B to an initial value (0 degree) (step S7). Since the phase difference between the clock signals output from the control circuits A and B is 0 degrees, the phase shift command which is transmitted from the LSI tester 160 to the phase control circuit 111 represents 0 degrees.

The LSI tester 160 transmits the oscillation command to the oscillator 11A in order to cause the oscillator 11A to output the clock signal (step S8). Then the oscillator 11A outputs the clock signal to the PLL 11B, and the PLL 11B generates the four-phase clock signals and inputs them to the phase control circuit 111. The control circuits A and B of the phase control circuit 111 output the differential clock signals, respectively. At this moment, the phase difference between the two pairs of the differential clocks is 0 degrees. The differential clock signals output from the control circuit A are input to the data input terminals d and dx of the differential DFF 112, and the differential clock signals output from the control circuit B are input to the clock input terminals ck and ckx. The differential DFF 112 outputs the output data signal DFFq from the data output terminal q. In a case where the phase difference of the clock signals output from the control circuits A and B is 0 degrees, the output data signal DFFq becomes ‘0’ (data).

The LSI tester 160 stores the value of the output data signal DFFq output from the differential DFF 112 into the memory 162 (step S9).

The LSI tester 160 determines whether the operation check test has been finished with respect to all of the predetermined phase differences (step S10). More specifically, at step S10, the LSI tester 160 determines whether the operation check test is finished by repeatedly shifting the phase of the clock signal output from the control circuit B by 5 degrees in a step-by-step manner until the phase difference reaches 355 degrees so that the phase difference covers the cycle (360 degrees). In this case, the cycle is equally divided into seventy two parts.

If the LSI tester 160 determines that the operation check test has not been finished with respect to all of the phase differences (S10: NO), the LSI tester 160 returns to step S11. The LSI tester 160 causes the control circuit B to shift the phases of the clock signals DFFck and DFFckx output from the control circuit B by 5 degrees (step S11). As a result, the phases of the differential clock signals DFFck and DFFckx are shifted by 5 degrees with reference to the phases of the differential data signals DFFd and DFFdx.

The LSI tester 160 goes to step S8 after finishing the process of step S11. Accordingly, the processes of steps S8 to S11 are repeatedly executed by the LSI tester 160 until the operation check test has been finished with respect to all of the phase differences. After executing the processes of steps S8 to S11 repeatedly until the phase of the clock signal DFFck reaches 355 degrees, the seventy two output data signals DFFq are stored in the memory 162 of the LSI tester 160.

If the LSI tester 160 determines that the operation check test has been finished with respect to all of the phase differences at step S10 (S10: YES), the LSI tester 160 goes to step S12. The LSI tester 160 compares the data of the seventy two output data signals DFFq with the expected value data and determines whether the data of the seventy two output data signals DFFq corresponds to the expected value data (step S12).

If the seventy two output data signals DFFq include thirty six ‘0’s and thirty two ‘1’s and do not include the data point(s) where ‘0’ or ‘1’ occurs discontinuously and unexpectedly, the LSI tester 160 determines that the seventy two output data signals DFFq correspond to the expected value data. In this case, the control circuit B passes the operation check test. In other words, the LSI tester 160 determines that the clock distribution circuit 110 including the phase control circuit 111 is a good product (non-defective product) for both of the control circuits A and B.

If number of ‘0’s and number of ‘1’s included in the seventy two output data signals DFFq are different or the seventy two output data signals DFFq include the data point(s) where ‘0’ or ‘1’ occurs discontinuously and unexpectedly, the LSI tester 160 determines that the seventy two output data signals DFFq do not correspond to the expected value data. In this case, the clock distribution circuit 110 including the phase control circuit 111 does not pass the operation check test. In other words, the LSI tester 160 determines that the clock distribution circuit 110 including the phase control circuit 111 is a defective product.

The LSI tester 160 finishes the first step of the operation check test of the control circuits A and B included in the phase control circuit 111 after finishing the process of step S12.

In this embodiment, the operation check test of the phase control circuit 111 is performed by shifting the phases of the clock signals output from the control circuits A and B independently in a manner as described above with reference to FIG. 6A. Accordingly, it becomes possible to check the operation of the control circuits A and B easily and precisely.

The two-phase and two-output phase control circuit 111 generates the output data signal DFFq by using the differential clock signals output from the control circuit A included in the phase control circuit 111 as the differential data signals DFFd and DFFdx and by using the different clock signals output from the control circuit B included in the phase control circuit 111 as the differential clock signals DFFck and DFFckx. In other words, the output data signal DFFq of the differential DFF 112 is obtained directly from the two pairs of the differential clock signals output from the two-phase and two-output phase control circuit 111. Accordingly, it becomes possible to determine whether the phase control circuit 111 operates normally or does not operate normally in a precise manner.

The output data signal DFFq is obtained by using the differential clock signals output from the control circuit A included in the phase control circuit 111 as the differential data signals DFFd and DFFdx and by using the different clock signals output from the control circuit B included in the phase control circuit 111 as the differential clock signals DFFck and DFFckx. Accordingly, it becomes possible to suppress generation of an unstable output data signal such as metastable signal, and to obtain the stable output data signals DFFq.

Since the LSI tester 160 causes the control circuits A and B of the phase control circuit 111 to shift the phases of the clock signals directly, it becomes possible to perform the operation check test in the whole phase adjustable range of the phase control circuit 111.

In the embodiment as described above, amounts of the phases shifted at steps S5 and S11 are equal to each other. The amounts of the phases shifted at steps S5 and S11 may be different from each other.

The second step of the operation check test is performed in a more precise manner than that of the first step of the designated phase unit. The second step is performed with respect to the phase control circuit 111 which is determined to be a good product at the first step of the operation check test.

In the following, processes of the second step of the operation check test will be described with reference to FIG. 6B.

FIG. 6B is a flowchart illustrating the processes executed in the second step of the operation check test. The processes as illustrated in FIG. 6B are executed by the LSI tester 160 which is connected to the high-speed serial I/O receiving circuit 100 according to the first embodiment.

Herein, the second step of the operation check test will be described in the same operational condition as that illustrated in FIG. 5. In the second step of the operation check test, the phases of the clock signals output from the control circuits A and B are shifted by 5 degrees in a step-by-step manner.

When the LSI tester 160 starts the second step of the operation check test, the LSI tester 160 sets the phases of the two pairs of the differential clock signals output from the control circuits A and B to initial values (step S13). In other words, the LSI tester 160 sets the output phases of the control circuits A and B to initial values. The LSI tester 160 executes the process of step S13 as a continuation to step S12 after finishing the process of step S12.

In the second step of the operation check test, the initial values of the output phases of the control circuits A and B are given by setting any one of the output phases of the control circuits A and B to 0 degrees while fixing the phase difference between the output phases of the control circuits A and B to the neighborhood value of the phase difference at which the data change point of the output data signal DFFq occurs.

At step S13, the LSI tester 160 sets the output phase of the control circuit A to 165 degrees and sets the output phase of the control circuit B to 0 degrees by using one of the neighborhood values (165 degrees). Herein, the phase shift command transmitted from the LSI tester 160 to the phase control circuit 111 represents 165 degrees.

Accordingly, the phase of the clock signal output from the control circuit A is set to be 165 degrees and the phase of the clock signal output from the control circuit B is set to be 0 degrees, respectively. In other words, the phase of the clock signal output from the control circuit A is set to be a phase which leads 165 degrees with reference to the phase of the clock signal output from the control circuit B while the phase of the clock signal output from the control circuit B is set to be 0 degrees. This operating point corresponds to the intersection point of the straight line (5) and the axis A.

The LSI tester 160 transmits the oscillation command to the oscillator 11A in order to cause the oscillator 11A to output the clock signal (step S14). Then the oscillator 11A outputs the clock signal to the PLL 11B, and the PLL 11B generates the four-phase clock signals and inputs them to the phase control circuit 111. The control circuits A and B of the phase control circuit 111 output the differential clock signals, respectively. At this moment, the phase difference between the two pairs of the differential clocks is 0 degrees. The differential clock signals output from the control circuit A are input to the data input terminals d and dx of the differential DFF 112, and the differential clock signals output from the control circuit B are input to the clock input terminals ck and ckx. The differential DFF 112 outputs the output data signal DFFq from the data output terminal q. In a state where the output phases are set to the initial values at step S13, the output data signal DFFq becomes ‘0’, if the phase control circuit 111 operates normally. This is because the straight line (5) exists in the operating areas in which the output data signal DFFq becomes ‘0’.

The LSI tester 160 stores the value of the output data signal DFFq output from the differential DFF 112 into the memory 162 (step S15).

The LSI tester 160 determines whether the operation check test has been finished with respect to the whole operating area of the control circuits A and B (step S16). More specifically, at step S16, the LSI tester 160 determines the completion of the operation check test by determining whether the output phases of the control circuits A and B have been shifted by 5 degrees in a step-by-step manner to the cycle (360 degrees).

If the LSI tester 160 determines that the operation check test has not been finished with respect to the whole operating area of the control circuits A and B at step S16 (S16: NO), the LSI tester 160 returns to step S17 and causes the phase control circuit 111 to shift both of the output phases of the control circuits A and B by 5 degrees (step S17). Accordingly, at step S17, both of the output phases of the control circuits A and B are shifted by 5 degrees along the straight line (5) as illustrated in FIG. 5.

In the embodiment as described above, amounts of the phases shifted at step S17 are equal to the amounts of the phases shifted at step S5 and S11, but the amounts of the phases shifted at step S17 may be different from the amounts of the phases shifted at step S5 and S11.

The LSI tester 160 goes to step S14 after finishing the process of step S17. Accordingly, the processes of steps S14 to S17 are repeatedly executed by the LSI tester 160 until the operation check test has been finished with respect to the whole operating area of the control circuits A and B. After executing the processes of steps S14 to S17 repeatedly until the output phases of the control circuits A and B reach the cycle, the seventy two output data signals DFFq are stored in the memory 162 of the LSI tester 160. These processes correspond to a case in which the seventy two output data signals DFFq are obtained by shifting the output phases of the control circuits A and B by 5 degrees in a step-by-step manner along the straight line (5).

If the LSI tester 160 determines that the operation check test has been finished with respect to the whole operating area at step S16 (S16: YES), the LSI tester 160 goes to step S18. The LSI tester 160 compares the data of the seventy two output data signals DFFq with the expected value data and determines whether the data of the seventy two output data signals DFFq corresponds to the expected value data (step S18). Herein, the expected value data always shows ‘0’ with respect to all of the output phases, if the second step of the operation check test is performed along the straight line (5).

The LSI tester 160 determines that the phase control circuit 111 passes the second step of the operation check test with respect to one of the neighborhood values, if all of the seventy two output data signals DFFq are ‘0’. In this embodiment, at step S18, the LSI tester 160 determines that the phase control circuit 111 passes the second step of the operation check test with respect to the neighborhood value (165 degrees).

On the contrary, the LSI tester 160 determines that the phase control circuit 111 does not pass the second step of the operation check test with respect to one of the neighborhood values, if at least one of the seventy two output data signals DFFq shows ‘1’. In other words, the LSI tester 160 determines that the phase control circuit 111 does not pass the second step of the operation check test with respect to one of the neighborhood values, if all of the seventy two output data signals DFFq are not ‘0’. In other words, the LSI tester 160 determines that the clock distribution circuit 110 including the phase control circuit 111 is a defective product.

In a case where the LSI tester 160 determines that the phase control circuit 111 passes the second step of the operation check test at step S18, the LSI tester determines whether the second step of the operation check test has been finished with respect to both of the neighborhood values (step S19).

If the LSI tester 160 determines that the second step of the operation check test has not been finished with respect to both of the neighborhood values, the LSI tester 160 returns to step S13 in order to perform the second step of the operation check test with respect to another neighborhood value. In this embodiment, the LSI tester 160 performs the second step of the operation check test with respect to another neighborhood value (170 degrees).

At step S13, the LSI tester 160 sets the output phase of the control circuit A to 170 degrees and sets the output phase of the control circuit B to 0 degrees by using the other of the two neighborhood values (170 degrees) in order to set the output phases of the control circuits A and B to initial values. Herein, the phase shift command transmitted from the LSI tester 160 to the phase control circuit 111 represents 170 degrees.

Accordingly, the phase of the clock signal output from the control circuit A is set to be 170 degrees and the phase of the clock signal output from the control circuit B is set to be 0 degrees, respectively. In other words, the phase of the clock signal output from the control circuit A is set to be a phase which leads 170 degrees with reference to the phase of the clock signal output from the control circuit B while the phase of the clock signal output from the control circuit B is set to be 0 degrees. This operating point corresponds to the intersection point of the straight line (6) and the axis A as illustrated in FIG. 5.

Thereafter, the LSI tester 160 executes the processes of steps S14 to S17 and obtains the seventy two output data signals DFFq while fixing the phase difference of the phases of the clock signals output form the control circuit A and the phases of the clock signals output form the control circuit B.

The LSI tester 160 compares the data of the seventy two output data signals DFFq with the expected value data and determines whether the data of the seventy two output data signals DFFq corresponds to the expected value data (step S18). Herein, the expected value data always shows ‘1’ with respect to all of the output phases, if the second step of the operation check test is performed along the straight line (6).

The LSI tester 160 determines that the phase control circuit 111 passes the second step of the operation check test with respect to the other of the two neighborhood values, if all of the seventy two output data signals DFFq are ‘1’. In this embodiment, at step S18, the LSI tester 160 determines that the phase control circuit 111 passes the second step of the operation check test with respect to the neighborhood value (170 degrees).

On the contrary, the LSI tester 160 determines that the phase control circuit 111 does not pass the second step of the operation check test with respect to the other of the two neighborhood values, if at least one of the seventy two output data signals DFFq shows ‘0’. In other words, the LSI tester 160 determines that the phase control circuit 111 does not pass the second step of the operation check test with respect to the other of the two neighborhood values, if all of the seventy two output data signals DFFq are not ‘1’. In other words, the LSI tester 160 determines that the clock distribution circuit 110 including the phase control circuit 111 is a defective product.

If the LSI tester 160 determines that the phase control circuit 111 passes the second step of the operation check test with respect to the other of the two neighborhood values at step S18, the LSI tester 160 determines that the second step of the operation check test has finished with respect to both of the two neighborhood values at step S19 (S19 YES).

As a result, the LSI tester 160 determines that the clock distribution circuit 110 including the phase control circuit 111 is a good product.

According to the embodiment as described above, the second step of the operation check test is performed with regard to the phase control circuit 111 which is determined as to be the good product at the first step of the operation check test. In the second step, the output phases of the control circuits A and B are shifted one cycle while fixing the phase difference of the output phases to the neighborhood values of the phase difference at which the data change point of the output data signal DFFq appears. Accordingly, it becomes possible to check the operation of the control circuits A and B easily and precisely.

As described above, the two-phase and two-output phase control circuit 111 generates the output data signal DFFq by using the differential clock signals output from the control circuit A included in the phase control circuit 111 as the differential data signals DFFd and DFFdx and by using the different clock signals output from the control circuit B included in the phase control circuit 111 as the differential clock signals DFFck and DFFckx. In other words, the output data signal DFFq of the differential DFF 112 is obtained directly from the two pairs of the differential clock signals output from the two-phase and two-output phase control circuit 111. Accordingly, it becomes possible to determine whether the phase control circuit 111 operates normally or does not operate normally in a precise manner without performing complex processing.

The output data signal DFFq is obtained by using the differential clock signals output from the control circuit A included in the phase control circuit 111 as the differential data signals DFFd and DFFdx and by using the different clock signals output from the control circuit B included in the phase control circuit 111 as the differential clock signals DFFck and DFFckx. Accordingly, it becomes possible to suppress generation of an unstable output data signal such as metastable signal, and to obtain the stable output data signals DFFq.

Since the LSI tester 160 causes the control circuits A and B of the phase control circuit 111 to shift the phases of the clock signals directly, it becomes possible to perform the operation check test in the whole phase adjustable range of the phase control circuit 111.

In the second step of the operation check test as described above, the output phases of the control circuits A and B are shifted by 5 degrees repeatedly in a step-in-step manner in order to obtain the output data signals DFFq output from the differential DFF 112, but the output phases of the control circuits A and B may be shifted by smaller angles such as 1 degree or less, for example. If the output phases of the control circuits A and B may be shifted by smaller angles in order to obtain the output data signals DFFq, it is possible to perform the operation check test more precisely.

In the embodiment as described above, the operation check test is performed with respect to the clock distribution circuit 110 including the differential DFF 112 which uses the differential clock signals output from the control circuit A included in the phase control circuit 111 as the differential data signals DFFd and DFFdx and uses the different clock signals output from the control circuit B included in the phase control circuit 111 as the differential clock signals DFFck and DFFckx.

The output data signal DFFq of the differential DFF 112 is obtained directly from the clock signals output from the phase control circuit 111. The phase control circuit 111 outputs the two pairs of the differential clock signals to the differential DFF 112. Since the differential DFF 112 generates the output data signal DFFq based on the differential clock signals output from the phase control circuit 111, it becomes possible to determine whether the phase control circuit 111 operates normally or does not operate normally in a precise and easy manner.

Since the LSI tester 160 causes the control circuits A and B of the phase control circuit 111 to shift the phases of the clock signals directly, it becomes possible to perform the operation check test in the whole phase adjustable range of the phase control circuit 111.

In the embodiment as described above, the clock distribution circuit 110 is included in the high-speed serial I/O receiving circuit 100 of the CPU 10. The clock distribution circuit 110 may be included in a part other than high-speed serial I/O receiving circuit 100 as long as the part requires the clock signal(s) and is included in the server 1.

In the embodiment as described above, the high-speed serial I/O receiving circuit 100 includes the amplifier 120, the DFE 130 and the data processing circuit 150. The high-speed serial I/O receiving circuit 100 may include a circuit other than the amplifier 120, the DFE 130 and the data processing circuit 150.

In the embodiment as described above, the LSI tester 160 is a type of an apparatus which is located outside of the server 1. The server 1, the high-speed serial I/O receiving circuit 100 or the clock distribution circuit 110 may include the LSI tester 160.

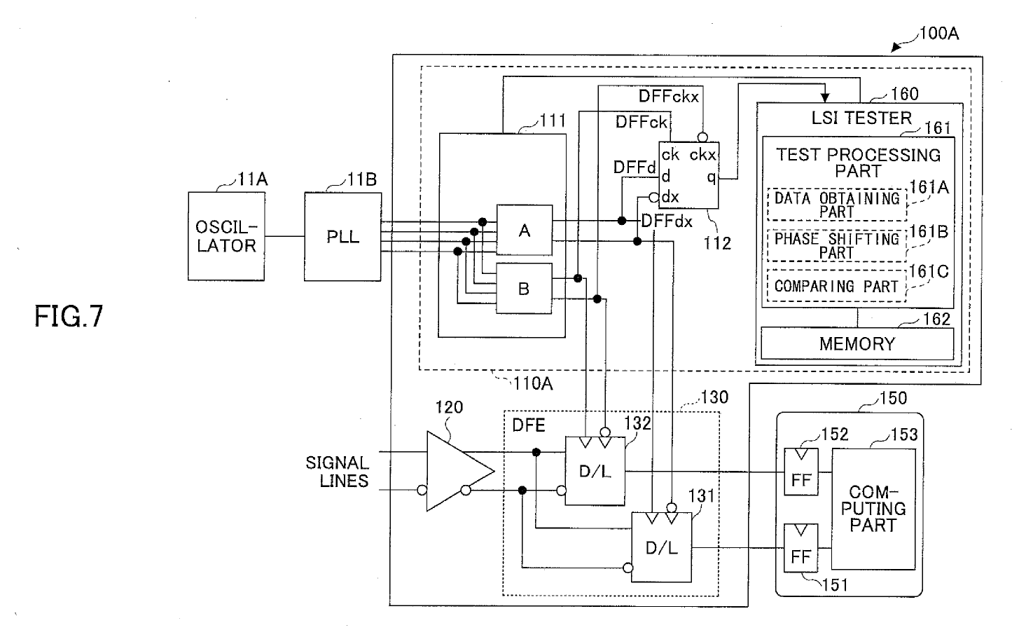

FIG. 7 is a diagram illustrating the high-speed serial I/O receiving circuit according to an exemplary variation of the first embodiment.

A clock distribution circuit 110A included in a high-speed serial I/O receiving circuit 100A according to the exemplary variation of the first embodiment is different from the clock distribution circuit 110 according to the first embodiment as illustrated in FIGS. 2 and 3 in that the clock distribution circuit 110A includes the LSI tester 160. In the exemplary variation of the first embodiment, the LSI tester 160 is one example of the operation check test apparatus. Further, the high-speed serial I/O receiving circuit 100A is different from the clock distribution circuit 110 according to the first embodiment as illustrated in FIGS. 2 and 3 in that the clock distribution circuit 110A does not include the test ports 140A and 140B, because the clock distribution circuit 110A includes the LSI tester 160. Otherwise, the high-speed serial I/O receiving circuit 100A and the clock distribution circuit 110A are similar to the high-speed serial I/O receiving circuit 100 and the clock distribution circuit 110 according to the first embodiment as illustrated in FIGS. 2 and 3. Accordingly, the same elements as or elements similar to those of the high-speed serial I/O receiving circuit 100 and the clock distribution circuit 110 of the first embodiment are referred to by the same reference numerals, and a description thereof is omitted.

In the exemplary variation of the first embodiment, as illustrated in FIG. 7, since the clock distribution circuit 110A includes the LSI tester 160, the high-speed serial I/O receiving circuit 100A includes the LSI tester 160. Similarly, the server 1 (see FIG. 1) includes the LSI tester 160. Although the clock distribution circuit 110A includes the LSI tester 160 as illustrated in FIG. 7, the LSI tester 160 may be provided outside of the clock distribution circuit 110A and included in the high-speed serial I/O receiving circuit 100A. Similarly, the LSI tester 160 may be provided outside of the high-speed serial I/O receiving circuit 100A and included in the server 1.

According to the exemplary variation of the first embodiment, the LSI tester 160 is included in the clock distribution circuit 110A, the high-speed serial I/O receiving circuit 100A or the server 1. Accordingly, it is possible to perform the operation check test of the phase control circuit 111 in a precise and easy manner.

### Second Embodiment

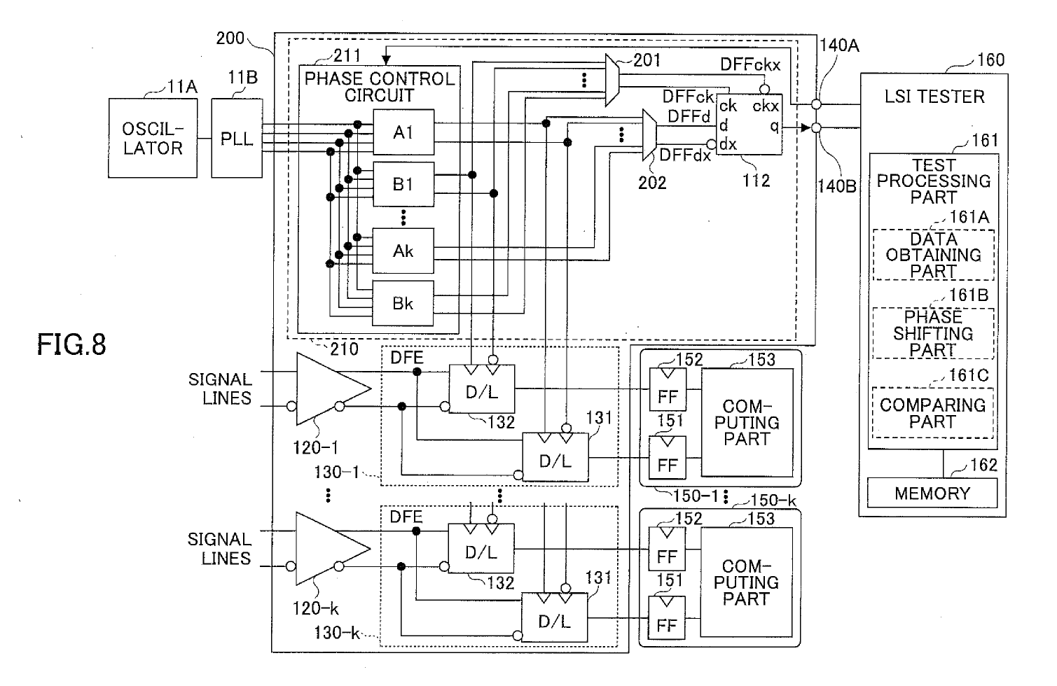

FIG. 8 is a diagram illustrating a high-speed serial I/O receiving circuit 200 including a clock distribution circuit 210 of the second embodiment.

The high-speed serial I/O receiving circuit 200 is different from the high-speed serial I/O receiving circuit 100 of the first embodiment in that the high-speed serial I/O receiving circuit 200 includes the clock distribution circuit 210, amplifiers 120-1 to 120-k and the DFEs 130-1 to 130-k. The clock distribution circuit 210 includes a two-phase and two-output phase control circuit 211, selectors 201 and 202, and the differential DFF 112. In the second embodiment, the amplifiers 120-1 to 120-k, the DFEs 130-1 to 130-k and the phase control circuit 211 have multistage configurations, respectively.

Herein, k represents a stage number, and k is integer number more than or equal to two. Otherwise, the high-speed serial I/O receiving circuit 200 is similar to the high-speed serial I/O receiving circuit 100 according to the first embodiment as illustrated in FIGS. 2 and 3. Accordingly, the same elements as or elements similar to those of the high-speed serial I/O receiving circuit 100 of the first embodiment are referred to by the same reference numerals, and a description thereof is omitted.

Herein, data processing circuits 150-1 to 150-k are connected to the high-speed serial I/O receiving circuit 200. The data processing circuits 150-1 to 150-k have multistage configurations as well.

The phase control circuit 211 includes k pairs of control circuits A1, B1, . . . , Ak, Bk. The control circuits A1, B1, . . . , Ak, Bk are used as k pairs of the control circuits. Each pair has the same suffix.

Input terminals of k pairs of input terminals of the amplifiers 120-1 to 120-k are connected to signal lines included in the CPU 10 (see FIG. 1). Output terminals of the amplifiers 120-1 to 120-k are connected to the DFEs 130-1 to 130-k, respectively. The amplifiers 120-1 to 120-k are connected to the corresponding DFEs 130-1 to 130-k.

Each of the DFEs 130-1 to 130-k includes the decision latches 131 and 132.

Output terminals of the data processing circuits 150-1 to 150-k are connected to the corresponding DFEs 130-1 to 130-k, respectively. Each of the data processing circuits 150-1 to 150-k include the flip flops (FFs) 151 and 152 and the computing part 153.

The clock distribution circuit 210 includes the selectors 201 and 202 between the phase control circuit 211 having the multistage configuration and the differential DFF 112.

Input terminals of the selector 201 are connected to the output terminals of the control circuits B1˜Bk. A pair of output terminals of the selector 201 is connected to the clock input terminals ck and ckx of the differential DFF 112. The selector 201 selects any one of the control circuits B1˜Bk and outputs the differential clock signals output from the selected control circuit to the clock input terminals ck and ckx of the differential DFF 112.

Input terminals of the selector 202 are connected to the output terminals of the control circuits A1˜Ak. A pair of output terminals of the selector 202 is connected to the data input terminals d and dx of the differential DFF 112. The selector 202 selects any one of the control circuits A1˜Ak and outputs the differential clock signals output from the selected control circuit to the data input terminals d and dx of the differential DFF 112.

The selector 201 selects one pair of lines from the k pairs of lines that are connected to the control circuits B1˜Bk based on a line select command input from the LSI tester 160. The selector 202 selects one pair of lines from the k pairs of lines that are connected to the control circuits A1˜Ak based on the line select command input from the LSI tester 160. The selector 201 selects one of the control circuits B1˜Bk as described above. The selector 202 selects one of the control circuits A1˜Ak as described above. Selectors 201 and 202 select one of the control circuits B1˜Bk and one of the control circuits A1˜Ak, respectively. A pair of the control circuits selected by the selectors 201 and 202 has the same suffix. The selector 201 selects any one of the control circuits B1 to Bk as described above. The selector 202 selects any one of the control circuits A1˜Ak as described above.

The differential clock signals output from the control circuits A1˜Ak are input to the corresponding decision latches 131 of the DFEs 130-1 to 130-k. The control circuits A1˜Ak corresponds to the DFEs 130-1 to 130-k, respectively. The differential clock signals output from the control circuits B1˜Bk are input to the corresponding decision latches 132 of the DFEs 130-1 to 130-k. The control circuits B1˜Bk corresponds to the DFEs 130-1 to 130-k, respectively.

Accordingly, the differential clock signals output from the control circuit A1 are input to the decision latch 131 of the DFE 130-1, and the differential clock signals output from the control circuit B1 are input to the decision latch 132 of the DFE 130-1. The differential clock signals output from the control circuit Ak are input to the decision latch 131 of the DFE 130-k, and the differential clock signals output from the control circuit Bk are input to the decision latch 132 of the DFE 130-k.

Herein, signal lines that connect the DFEs 130-2 to 130-(k−1), the control circuits A2˜A(k−1) and B2˜B(k−1) or the like are omitted.

The LSI tester 160 causes the selectors 201 and 202 to select control circuits A1, B1, . . . , Ak, Bk by using the line select command, and performs the operation check test of the phase control circuit 211 which has the multistage configuration by executing the processes as described with reference to FIGS. 6A and 6B.

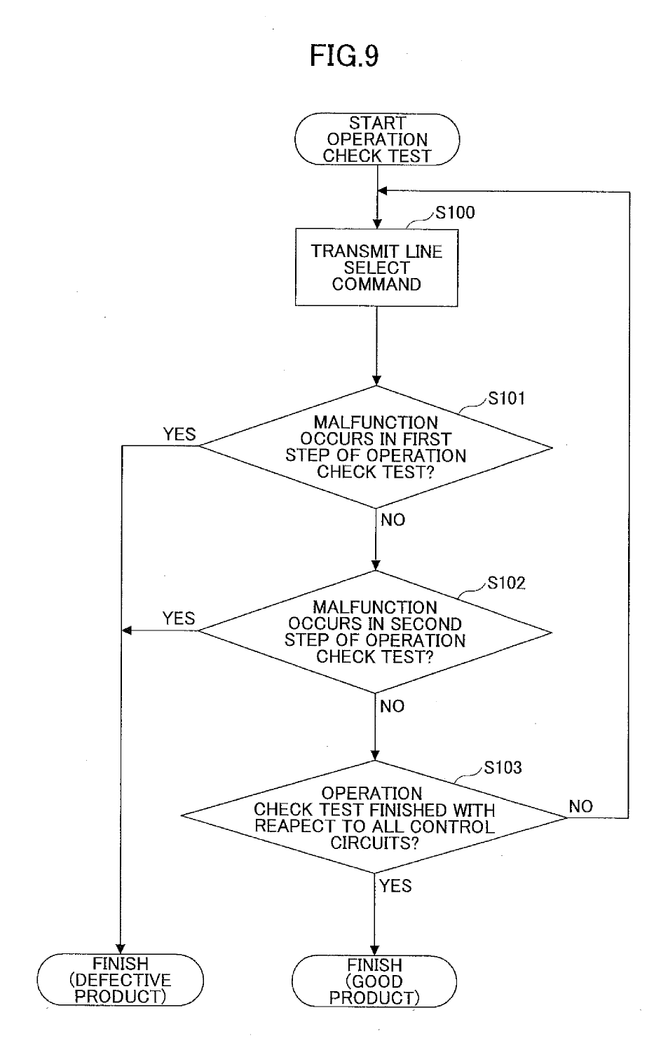

In the following, a process of the LSI tester 160 for switching the selector 201 and 202 by using the line select command will be described with reference to FIG. 9.

FIG. 9 is a flowchart illustrating the processes executed in the operation check test of the second embodiment. The processes as illustrated in FIG. 9 are executed by the LSI tester 160 which is connected to the high-speed serial I/O receiving circuit 200 according to the second embodiment.

The processes of the operation check test as illustrated in FIG. 9 include a step S100 for outputting the line select command in addition to the processes of the first and the second steps of the operation check test as illustrated in FIGS. 6A and 6B.

Since the first and the second steps of the operation check test of the second embodiment are similar to those of the first embodiment, the descriptions of the first and the second steps of the operation check test are omitted. Further, in the flowchart, the first and the second steps of the operation check test are simplified.

The LSI tester 160 transmits the line select command to the selectors 201 and 202 in order to perform the operation check test by selecting each pair of the control circuits A1˜Ak and B1˜Bk of the phase control circuit 211 (step S100). The process of step S100 is repeatedly executed by the LSI tester 160 until the LSI tester 160 causes the selectors 201 and 202 to select all pairs of the control circuits A1˜Ak and B1˜Bk. In other words, the LSI tester 160 causes the selectors 201 and 202 to select the first pair of the control circuits A1 and B1 to the last pair of the control circuits Ak and Bk in order by executing the process of step S100 repeatedly.

The LSI tester 160 performs the first step of the operation check test and determines whether the malfunction of the phase control circuit 211 occurs (step S101).

The process of step S101 is realized by steps S1 to S12 as illustrated in FIG. 6A. In other words, the process of step S101 is constituted of the processes of steps S1 to S12. The LSI tester 160 determines whether the malfunction of the phase control circuit 211 occurs by performing the first step of the operation check test of the phase control circuit 211 at step S101. The LSI tester 160 performs the first step of the operation check test of the control circuits A1˜Ak and B1˜Bk one by one at step S101 while performing the processes of steps S100 to S103 repeatedly.

If the LSI tester 160 determines that the malfunction of the phase control circuit 211 occurs at step S101, i.e. at step S6 or S12 as illustrated in FIG. 6A, the LSI tester 160 determines that the phase control circuit 211 is a defective product (S101 YES). In this case, the LSI tester 160 finishes the operation check test.

If the LSI tester 160 determines that the phase control circuit 211 does not malfunction at the first step of the operation check test, i.e. at step S101 (S101 NO), the LSI tester 160 performs the second step of the operation check test and determines whether the malfunction of the phase control circuit 211 occurs (step S102).

The process of step S102 is realized by steps S13 to S19 as illustrated in FIG. 6B. In other words, the process of step S102 is constituted of the processes of steps S13 to S19. The LSI tester 160 determines whether the malfunction of the phase control circuit 211 occurs by performing the second step of the operation check test of the phase control circuit 211 at step S102. The LSI tester 160 performs the second step of the operation check test of the control circuits A1˜Ak and B1˜Bk one by one at step S102 while performing the processes of steps S100 to S103 repeatedly.

If the LSI tester 160 determines that the malfunction of the phase control circuit 211 occurs at step S102, i.e. at step S18 as illustrated in FIG. 6B, the LSI tester 160 determines that the phase control circuit 211 is a defective product (S102 YES). In this case, the LSI tester 160 finishes the operation check test.

If the LSI tester 160 determines that the malfunction of the phase control circuit 211 does not occur at the second step of the operation check test (S102 NO), the LSI tester 160 determines whether the operation check test has been finished with respect to all of the control circuits A1˜Ak and B1˜Bk (step S103). The LSI tester 160 can perform process of step S103 by determining whether the stage number reaches k, for example.

If the LSI tester 160 determines that the operation check test has not been finished with respect to all of the control circuits A1˜Ak and B1˜Bk at step S103 (S103 NO), the LSI tester 160 returns to step S100. At step S100, the LSI tester 160 transmits the line select command to the selectors 201 and 202 in order to switch the connections of the input terminals of the selectors 201 and 202 to the next pair of the control circuits having the next stage number among the control circuit A1˜Ak and B1˜Bk.

If the LSI tester 160 determines that the operation check test has been finished with respect to all of the control circuits A1˜Ak and B1˜Bk (S103 YES), the LSI tester 160 determines that all of the control circuits A1˜Ak and B1˜Bk included in the phase control circuit operate normally and finishes the processes as illustrated in FIG. 9. As a result, it turns out that the clock distribution circuit 210 including the phase control circuit 211 according to the second embodiment is a good product.

According to the second embodiment as described above, it is possible to perform the operation check test with respect to the control circuits A1˜Ak and B1˜Bk included in the phase control circuit 211 in a similar manner to that of the control circuits A and B included in the phase control circuit 111 according to the first embodiment.

### Third Embodiment

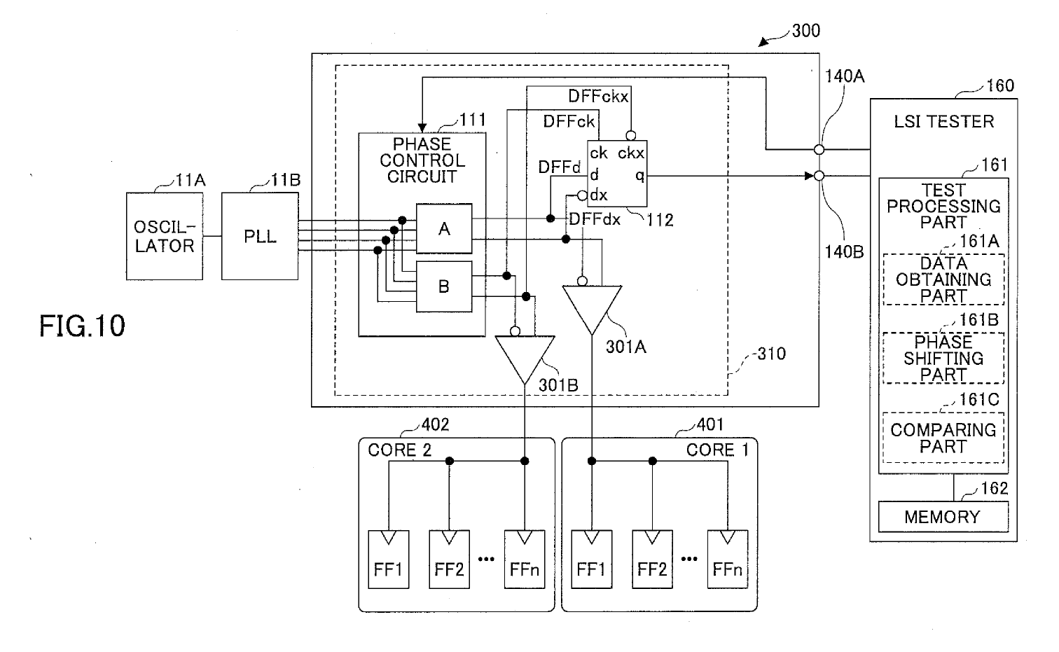

FIG. 10 is a diagram illustrating a clock distribution circuit 310 according to the third embodiment.

A high-speed serial I/O receiving circuit 300 including the clock distribution circuit 310 is different from the clock distribution circuit 110 according to the first embodiment in that the high-speed serial I/O receiving circuit 300 includes clock distributors 301A and 301B that are connected to the control circuits A and B of the phase control circuit 111. Cores 401 and 402 are connected to output sides of the clock distributors 301A and 301B, respectively. The clock distribution circuit 310 may be provided anywhere in the server 1 (see FIG. 1).

The cores 401 and 402 include flip flops FF1˜FFm and are connected to the output sides of the clock distributors 301A and 301B. Herein, m is integer number more than or equal to two. Each of the cores 401 and 402 is a type of a processor core. The cores 401 and 402 perform designated processing such as integer arithmetic or floating point arithmetic based on data which is input via the clock distributors 301A and 301B, respectively.

The operation check test of the phase control circuit 111 included in the clock distribution circuit 310 according to the third embodiment may be performed in a similar manner to that of the operation check test of the phase control circuit 111 included in the clock distribution circuit 110 according to the first embodiment.

It is possible to perform the operation check test of the phase control circuit 111 of the clock distribution circuit 310 according to the third embodiment in a similar manner to that of the phase control circuit 111 according to the first embodiment.

So far, the preferred embodiments and modification of the method for performing operation check test, the computer-readable, non-transitory medium storing a program which, when executed by a computer, causes the computer to perform the operation check test, and the clock distribution circuit are described. However, the invention is not limited to those specifically described embodiments and the modification thereof, and various modifications and alteration may be made within the scope of the inventions described in the claims.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiments of the present inventions have been described in detail, it should be understood that the various changes, substitutions, and alterations could be made hereto without departing from the spirit and scope of the invention.

What is claimed is:

1. A method carried out by a computer to perform an operation check test of a phase control circuit of a clock distribution circuit, the clock distribution circuit including the phase control circuit which controls at least one of phases of first differential signals and second differential signals, and a differential DFF which uses one of the first differential signals and the second differential signals as clock signals and obtains the other of the first differential signals and the second differential signals as data signals in synchronization with the clock signals, the method comprising:
first shifting one of the phases of the first differential signals and the second differential signals with reference to the other of the phases of the first differential signals and the second differential signals;
first obtaining an output data signal of the differential DFF to which the first differential signals and the second differential signals are input, one of the phases of the first differential signals and the second differential signals being shifted by the first shifting; and
first comparing first values of plural of the output data signals with first expected data values, the first values of the plural output data signals being obtained by performing the first shifting and the first obtaining repeatedly until phase differences of the first differential signals and the second differential signals reach one cycle of the first differential signals and the second differential signals.

2. The method as claimed in claim 1, further comprising:
second shifting the other of the phases of the first differential signals and the second differential signals with reference to one of the phases of the first differential signals and the second differential signals, in a case where the first values and the first expected data values compared at the first comparing correspond to each other;
second obtaining the output data signal of the differential DFF to which the first differential signals and the second differential signals are input, the other of the phases of the first differential signals and the second differential signals being shifted by the second shifting; and
second comparing second values of the plural output data signals with second expected data values, the second values of the plural output data signals being obtained by performing the second shifting and the second obtaining repeatedly until phase differences of the first differential signals and the second differential signals reach one cycle of the first differential signals and the second differential signals.

3. The method as claimed in claim 2, further comprising:
fixing the phase differences of the first differential signals and the second differential signals to a fixed value, in a case where the second values and the second expected data values compared at the second comparing correspond to each other;
third obtaining the output data signal of the differential DFF to which the first differential signals and the second differential signals are input, the phase differences of the first differential signals and the second differential signals being fixed to the fixed value by the fixing;
third shifting the phases of the first differential signals and the second differential signals by a designated degree while fixing the phase differences to the fixed value; and
third comparing third values of the plural output data signals with third expected data values, the third values of the plural output data signals being obtained by performing the third obtaining and the third shifting repeatedly until an amount of the phases shifted by the third shifting reaches one cycle of the first differential signals and the second differential signals.

4. The method as claimed in claim 3, wherein the fixed value is a neighborhood value of the phase differences at which data change point of the output data signal appears, and wherein all of the third expected data values are equal to each other.

5. The method as claimed in claim 4, wherein the neighborhood value includes a first neighborhood value and a second neighborhood value that catch the data change point therebetween, and wherein the fixed value is set to be the first neighborhood value or the second neighborhood value.

6. A clock distribution circuit comprising:
a phase control circuit configured to control at least one of phases of first differential signals and second differential signals;
a differential DFF configured to use one of the first differential signals and the second differential signals as clock signals and to obtain the other of the first differential signals and the second differential signals as data signals in synchronization with the clock signals;
an output terminal configured to output an output data signal of the differential DFF to an operation check test apparatus which performs an operation check test of the phase control circuit; and
an input terminal configured to input a phase shift command which causes one of phases of the first differential signals and the second differential signals to shift with reference to the other of the phases of the first differential signals and the second differential signals from the operation check test apparatus to the phase control circuit;
wherein the phase control circuit shifts one of the phases of the first differential signals and the second differential signals with reference to the other of the phases of the first differential signals and the second differential signals in accordance with the phase shift command.

7. A computer-readable, non-transitory medium storing a program which, when executed by a computer, causes the computer to perform an operation check test of a phase control circuit of a clock distribution circuit, the clock distribution circuit including the phase control circuit which controls at least one of phases of first differential signals and second differential signals, and a differential DFF which uses one of the first differential signals and the second differential signals as clock signals and obtains the other of the first differential signals and the second differential signals as data signals in synchronization with the clock signals, the method comprising:
shifting one of the phases of the first differential signals and the second differential signals with reference to the other of the phases of the first differential signals and the second differential signals;
obtaining an output data signal of the differential DFF to which the first differential signals and the second differential signals are input, one of the phases of the first differential signals and the second differential signals being shifted by the shifting; and
comparing first values of plural of the output data signals with first expected data values, the first values of the plural output data signals being obtained by performing the shifting and the obtaining repeatedly until phase differences of the first differential signals and the second differential signals reach one cycle of the first differential signals and the second differential signals.
